(19) United States
(12) Patent Application Publication
(10) Pub. No.: US 2021/0337064 A1
(43) Pub. Date: Oct. 28, 2021

(54) Method for providing an resource or information in an electronic device

(71) Applicant: Xiaolin ZHANG, Shanghai (CN)

(72) Inventor: Xiaolin ZHANG, Shanghai (CN)

(21) Appl. No.: 17/368,572

(22) Filed: Jul. 6, 2021

Related U.S. Application Data
(63) Continuation of application No. PCT/CN2019/104450, filed on Sep. 4, 2019.

(30) Foreign Application Priority Data
Sep. 6, 2018 (CN) 2018110387485
Oct. 19, 2018 (CN) 2018112244274
Dec. 26, 2018 (CN) 2018116014623
Dec. 26, 2018 (CN) 2018116046770
Dec. 26, 2018 (CN) 2018116085046
Dec. 26, 2018 (CN) 2018222044405
Jan. 3, 2019 (CN) 2019100055933
Jan. 22, 2019 (CN) 2019100605736
Jan. 29, 2019 (CN) 2019100878432
Jan. 29, 2019 (CN) 2019100883252
Mar. 8, 2019 (CN) 2019101770209
Mar. 22, 2019 (CN) 2019102240638
Mar. 28, 2019 (CN) 2019102433005
Apr. 4, 2019 (CN) 2019102790093
Apr. 8, 2019 (CN) 2019102800076
Apr. 19, 2019 (CN) 2019103221795
Apr. 29, 2019 (CN) 2019103225033
Aug. 15, 2019 (CN) 2019107561866

(51) Int. Cl. H04M 1/72466; H04M 1/72469

(52) U.S. Cl. CPC H04M 1/72466; H04M 1/72469

(57) ABSTRACT

The present invention discloses a UI integrating method, a UI navigating method and a electronic device, computer readable storage medium, relates to the technical field of IM, which comprises: A) presenting a first communication UI for a first contact on said display for said electronic device, said first communication UI comprising a message area; B) outputting a plurality of messages with the first contact via at least one communication network to said message area at least partially in response to an operation of an operation interface for the at least one communication network by a user, thereby improving accessibility of the electronic device.

### TECHNICAL FIELD

The described embodiments relate generally to information presentation, more particularly to configuration of UI or network resources in an electronic device.

### BACKGROUND

The development of technology has greatly changed human's communication manner. The continuous emergence of smart terminal products, such as smart phone, and various applications (APP) causes people not to be limited by physical distance, instead, enabling people communicate with their family, colleagues and friends anytime and anywhere.

However, there are some users comprising but are not limited to the elderly and children in real life. It is difficult for these users to become fit for the ever-changing technological development, upgrading of various communication means due to lack of abilities, so they are not expertise at smart terminals, user equipment (UE) and various communication Apps, which may result in the lack of communication with their family and friends.

It would be more of the case abovementioned in the following scenario: the youth works in big cities, while his elderly parents and young children may stay in his distant home. Even if the youth buys smart phone for the elderly and install various communication apps and other apps, the elderly is often unable to operate the smart phones and various apps inside, consequently failing to establish an effective communication with family and friends.

On the other hand, the technical roadmap of related communication technologies and related communication application software technologies have also gone through a process of multiple generations of complex evolution process.

The communication system can provide subscribers with a fixed line connection or a wireless connection for communication, such as voice communication or data communication. An instance of a fixed line system is the Public Switched Telephone Network (PSTN). One instance of a wireless communication system is a Public Land Mobile Network (PLMN), and another instance is a mobile communication system based on satellite. Wireless communication typically occurs via a radio frequency connection between the subscribers' mobile station and at least one network element of the communication system. Communication within the network is usually, but not necessarily, handled by fixed line connections between different network elements. Communication transmission may also occur within a system that comprises one or more data networks. One example of such communication is an IP (Internet Protocol) voice scheme of a voice call over a packet switched data network.

A communication network is a cellular wireless network comprised by access entities commonly called sub-area. In most cases, a sub-area is defined as a certain coverage area by one or more base transceiver station (BTS) that provide service to user equipment (UE) such as a mobile station (MS) via a wireless interface possibly connected with a base station subsystem (BSS). Several sub-areas cover a larger area and usually form a wireless coverage area called as a Location Area (LA) or a Routing Area (RA) in some standards. It should be appreciated that the size of the location area or routing area depends on the system and environment and may be equal to one sub-area or smaller, such as part of the coverage area of the base station. One feature of a cellular system is that it provides the mobile station with mobility.

Wireless communication is a communication manner by only electromagnetic waves but not via cables. Wireless communication mainly comprises microwave communication and satellite communication. Microwave is a type of radio wave that travels no more than tens of kilometers. However, the microwave has a wide frequency band and a large communication capacity. An microwave relay station every few tens of kilometers is needed for microwave communication. Satellite communication is microwave communication between two or more earth stations or mobile bodies on the ground by utilizing communication satellites as relay stations.

Wireless Communication is a communication manner of information exchange utilizing the feature that electromagnetic wave signals can propagate in free space. In recent years, the fastest growing and most widely used in the information communication field is wireless communication technology. Wireless communication implemented in mobile manner is also generally called as mobile communication, and the above two as are named with a combined term of wireless mobile communication. In the network standard of wireless mobile communication, the mobile phone network standard for mobile users mainly comprises GSM, CDMA, 5G, 4G, and the mobile phone has experienced, since its birth, the first generation of analog mobile phones (1G) and second generation of digital mobile phones (2G) compatible to GSM, TDMA and so on, 2.5th generation mobile communication technology of CDMA, third-generation mobile communication technology, fourth-generation mobile communication technology.

During this period, the full digitalization began with GSM (Global System for Mobile Communications) which developed on the basis of cellular system and belongs to the second generation of digital mobile communication system. It is featured with the most mature and advanced technology, and many types of available services of mobile communication, fast connection/hand-over speed, good call quality, strong security and confidentiality, strong anti-interference ability and wide network coverage. In terms of topology, the public mobile communication network generally adopts the cellular topology, which is based on the consideration of improving spectrum utilization, reducing mutual interference, and increasing system capacity.

In order to support not only the traditional voice service but the data service, GPRS superimposes the network for high-speed packet data on the basis of the original GSM network, and provides users with functions such as WAP browsing (browsing Internet pages) and E-mail to promote mobile data services by a first leap and achieve the perfect combination of mobile communication technology and data communication technology (especially Internet technology).

Most of the mobile communication is digital from the second generation of GSM, in addition to voice communication, sending and receiving text messages (short message, SMS), MMS (technology)|MMS (MMS, multimedia messaging service), wireless application protocol (WAP), etc. are enabled. Thereamong, the short message service (SMS) is part of the “integrated communication” service plan, and the text or digital information directly sent or received by the user through the mobile phone or other telecommunication terminal, the number of characters that the user can receive and send the short message each time is 160 for English, numeric characters, or 70 for Chinese. Generally speaking, the term “mobile data traffic” refers to data traffic generated by using mobile communication technologies such as GPRS, EDGE, TD-SCDMA, HSDPA, WCDMA, LTE, etc., or using related data value-added services, rather than the data traffic generated by WLAN, CSD or other manner of visiting internet. The mobile communication network among mobile users or between the mobile user and the fixed user falls into 2 categories: a public mobile communication network and a dedicated mobile communication network according to the service object; and can be classified into a mobile telephony network and a mobile data network according to service property. The mobile phone network supports communication in the form of SMS message and voice. Correspondingly, the terminal device is configured with a SMS message interface and a voice interface, thereby accessing to the mobile phone network, sending and receiving short messages and calling/receiving calls via the voice network.

In addition, the mobile terminal can be accessed to the Internet by the mobile data traffic based on the public mobile data network abovementioned, or can be accessed to the Internet through a WLAN access point derived from the traditional home or enterprise broadband, thereby utilizing various network services and programs, one of which is real-time communication.

Full name of the WLAN is Wireless Local Area Network, which is a system for data transmission by radio frequency (RF) technology. This technology is used to make up for the shortage of wired LAN so as to achieve the purpose of network extension, realizing a smooth network without network cable and without distance limitation. At present, the protocol standards included in the WLAN are: IEEE802.11b protocol, IEEE802.11a protocol, IEEE802.11g protocol, IEEE802.11E protocol, IEEE802.11i protocol, Wireless Application Protocol (WAP), etc., and WIFI (Wireless Fidelity) technology is a wireless network communication technology based on the IEEE 802.11 family of standards. The two communication networks of mobile data network and WLAN are called wireless data transmission network in the industry.

Instant Messaging (IM), derived from the above communication technology, is a real-time communication system (generally comprising some services and client application software). It allows two or more people to use the network to deliver text messages, files, data, voice and video communication in real time manner, related application comprising ICQ, Skype, MSN before the mobile data network was not popular, and subsequently, with the popularization of wireless data transmission technologies such as mobile data networks, WLAN and operating system for smartphone, there emerges a large number of mobile instant messaging services and software such as WeChat. There is an urgent need for a communication method and related device based on the above communication technology and application software technology to meet various potential needs of users comprising but not limited to elderly people, children, and the like.

### SUMMARY

It would be beneficial to improve the accessibility to the application and relevant information by the user interface (UI) of electronic device.

An embodiment of the present invention provides a resource providing method for an electronic device, wherein said electronic device comprises an operation interface for activating communication via at least one communication network, the method comprising the following 2 steps:

I) presenting a first communication UI for a first contact on said display for said electronic device, said first communication UI comprising a message area;

II) outputting a plurality of messages with the first contact via the at least one communication network to said message area at least partially in response to an operation of/on said operation interface by a user.

Another embodiment of the present invention provides a resource providing method for an electronic device, wherein said electronic device comprises an operation interface for activating communication via at least one communication network, the method comprising:

a) presenting a first communication UI (User Interface) for a first contact on said display for said electronic device, said first communication UI comprising a message area;

b) outputting a plurality of messages with the first contact via the at least one communication network to said message area at least partially in response to an operation of the operation interface by a user.

Another embodiment of the present invention provides a resource providing method for an electronic device, wherein the electronic device comprises an operation interface for communication, associated with at least one communication network, and the method comprises the following three steps:

A) presenting a communication interface for a first contact or a first contact group on display, and the communication interface comprises a message area;

B) establishing communication with the first contact or member of the first contact group via the at least one communication network to generate a plurality of messages in response to a user operation of/on the operation interface for communication; and

C) outputting the plurality of messages by the message area on the communication interface for the first contact.

Another embodiment of present invention provides a resource providing method for an electronic device, wherein the electronic device comprises an operation interface for communication, associated with at least one communication network, and the method comprises following 3 steps:

i) presenting a communication interface for a first contact or a first contact group on a display for the electronic device, and the communication interface comprises a message area;

ii) establishing communication with the first contact or member of the first contact group via the at least one communication network to generate a plurality of messages at least partially in response to a user operation of operation interface for communication; and

iii) outputting the plurality of messages via the message area on/in the communication interface for the first contact.

Still another embodiment of present invention provides a resource providing method for an electronic device, wherein said electronic device comprises an operation interface for activating communication via at least one communication network, the method comprising:

STEP A): presenting a first communication UI for a first contact on said display for said electronic device, said first communication UI comprising a message area;

STEP B): outputting a plurality of messages with the first contact via the at least one communication network to said message area at least partially in response to an operation of said operation interface by a user.

Optionally, the operation interface for activating communication (referred to as the operation interface for communication in some other embodiments), is configured, in the machine/device, as a human machine interface in the form of software or hardware for the user to operate to establish/trigger communication of the electronic device. In various scenarios of other embodiments, the operation interface for activating communication may be shorted as “operation interface” or “operation interface for communication”, and may also be appreciated as an communication enabling unit, an user interface element, an communication operating option, and the like, which may be implemented as virtual key and/or physical key.

And, “the first communication UI for a first contact” may, in some other embodiments, be shorted as “the first communication UI” or “communication interface for the first contact”. And “ communication interface” may also be called as “ communication UI”.

It should be noted, the interface element, such as the operation interface for communication or the menu item, is an software option for operator. the operation interface may be regarded as a global interface element retained across the interface, which is kept at the bottom of the display or the current interface during the switching process. And in the step ii), if the electronic device comprises a display and the corresponding touch-sensitive surface, the “electronic device's response to the user operation of the operation interface for communication” may comprise, the response to user gestures for the interface element by the touch-sensitive surface or the touch screen of the electronic device, wherein the user gestures include but not limited to sliding, dragging, clicking, or selecting of the interface element. For example, at an electronic device having one or more processors, memory, touch-sensitive surface, and a display, “electronic device's response to user operation of the operation interface for communication ” may comprise response to user input or operation by the contact/gesture at a location on the touch-sensitive surface that corresponds to the location of the interface element such as the operation interface for communication. If the display for the electronic device is a display or monitor compatible with a personal computer, the “electronic device's response to the user operation of the operation interface for communication” may comprise response to the user operation of the interface element(s) by hardware interface such as a mouse or a keyboard, etc, wherein the user operation includes but not limited to sliding, dragging, clicking or selecting. If the display for the electronic device is a television set, the “electronic device's response to the user operation of operation interface for communication” may comprise response to the operation of the interface element(s) by hardware interface such as a remote controller or operating key in the television set, etc. wherein the user operation includes but not limited to sliding, dragging, clicking or selecting. The electronic device's response to user operation for the interface element described herein is also applicable to the response, of the electronic device, to the same or similar operation(s) in any other embodiment in response to the user operation for the interface element, which will not be repeated elsewhere.

In addition, in some cases, such as a scenario in which the user initiates communication, in the electronic device, in response to the user operation of the operation interface for communication, initiating communication with the first contact or the member of the first contact group via the at least one communication network, and outputting a plurality of messages generated in the communication initiated by the user via the message area in/on the communication interface for the first contact. In still other cases, for example, the user's electronic device receives some message(s) from the first contact, and the communication with the first contact or the member of the first contact group is established in the electronic device to generate a plurality of messages via the at least one communication network, optionally, the communication establishing process for receiving the message(s) can be automatically completed without the need of the user operation of the operation interface for communication. Herein, the description for the communication establishment in the step ii) is also applicable to the same or similar step in the other embodiments.

Optionally, the outputting step of the method in some embodiments further comprises: in response to the occurrence of the latest one of the plurality of messages, outputting the latest one in the message area, and the profile of the contact corresponding to the of the latest message is separately configured at a location outside the message area on the contact interface, and the profile is no longer revealed in the message area.

Optionally, the outputting step in some embodiments further comprises: outputting only the latest one, continuously being updated, of the plurality of messages in the message area on the communication interface for the first contact or the message area of the first contact group, the profile is separately configured at a location outside the message area in the contact interface, and the profile of the related contact is no longer revealed in the message area.

Optionally, the latest message that occurs between the contact(s) in some embodiments comprises both the latest message received from the contact(s) and the latest message sent to the contact(s). Specifically, a first message occurs with the first contact or the second contact at the last moment and is separately displayed in the message area. Currently, a second message occurs between the first contact and the first contact, and the step of outputting the latest message in the method of some embodiments further comprises: in response to the second message sending to or receiving from the first contact, replacing the previous message (i.e., the first message abovementioned) with the second message for being separately displayed in the message area. Similarly, the first message may be a message received from or sent to the first contact/a second contact. Of course, it should be understood that the second message may be a reply to the first message or may be irrelevant, contextually or logically, to the first message, which is also applicable to the situation of communication between user of the electronic device and a plurality of contacts in contact group.

In “receiving→replying” scenario of some embodiments, the step of separately outputting the latest message by the message area further comprises: sub-step A) in response to receiving a third message from the first contact, separately displaying the third message in the message area, namely, displaying only the third message in the message area, sub-step B) in response to the user activating the sending key of the “operation interface for communication”, sending a reply message for the third contact and replacing the latest received message with the reply message, i.e., the above third message, for being displayed separately in the message area. For the scenario of “sending→receiving” in the process of communication with the members of the contact group in other embodiments, the above step of separately outputting the latest message by the message area further comprises: sub-step C) in response to the user activating the sending key of the operation interface for communication in the first contact group interface, sending a fourth message for the third contact of the first contact group and separately displaying the fourth message in the message area, sub-step D) in response to receiving a seventh message from the third contact or a fourth contact, replacing the fourth message with the seventh message and separately displaying the seventh message in the message area. In the process of communication with the members of the contact group in other embodiments, the above step of separately outputting the latest message by the message area further comprises: sub-step E) in response to the user activating the sending key of the operation interface for communication in the first contact group interface, sending a fifth message for the fourth contact in the first contact group and replacing the current message in the message area with the fifth message for being and separately displaying the fifth message in the message area, sub-step F) in response to the user activating the sending key of the operation interface for communication in the first contact group interface, sending a sixth message for the fifth contact in the first contact group and replacing the fifth message with the sixth message in the message area for being displayed separately in the message area.

Optionally, in some embodiment(s), the message outputting step further comprises the step A-B) sending/receiving a first message of said plurality of messages to/from the first contact;

displaying only the first message in the message area;

in response to a second message of said plurality of messages from/to the first contact, displaying only the second message in place of the first message in the message area, wherein the first message is the last/previous one of said plurality of messages from/to the first contact.

Further optionally, the step A-B) further comprises following three sub-step:

A-1) in response to recently receiving the first message from the first contact, displaying only the first message in the message area; A-2) in response to the user activating said operation interface, sending the second message to the first contact ; A-3) displaying the second message in place of the first message in the message area.

Alternatively, the step A-B) further comprises following three sub-step:

B-1) in response to the user activating said operation interface, sending the first message to the first contact ; B-2) displaying, in the message area, only the first message most recently sent; B-3) in response to receiving the second message from the first contact, displaying the second message in place of the first message in the message area.

Optionally, prior to the step of outputting the latest message, the method further comprises: a) the step of sending the latest message: in response to a user operation of the operation interface for communication or a user operation of the message area, providing a message inputting interface and sending the message that the user inputs by the message inputting interface, wherein the message inputting interface may comprises a soft keyboard and the message area as an input box, or, the message inputting interface may also comprises hardware such as a microphone for audio collection, and, optionally, may further comprise an interface element for prompting audio collection or the like After the above step of outputting the latest message, the method may further comprise: b) the step of accessing the latest message: in response to a user operation of/on the operation interface for communication or a user operation of/on the message area, outputting the latest message in audio or in text by the message area, wherein the textual output for the latest message may be a complete and/or amplified output for the entire message.

Optionally, in some embodiments, at least one communication network comprises a plurality of communication networks, the plurality of messages corresponds to the plurality of communication networks and the plurality of messages fall into different category of service properties, and the operation interface for communication comprises a key group that is virtually provided in the communication interface for the first contact and/or physically provided in the electronic device, with the key group associated with a plurality of communication networks.

Optionally, in some embodiments, the profile for the first contact is separately configured outside the message area. A plurality of messages comprises at least two of voice service message, short message service message and data service message; the plurality of communication networks comprise a plurality of wireless communication networks, the plurality of wireless communication networks comprise a mobile phone network and a wireless data transmission network; and the outputting step further comprises: integrating at least two of the voice service message, the SMS message and the data service message to output only the latest one therein in the message area, with the latest one message continuously updated.

Optionally, in some embodiments, the profile and the message area are configured up and down substantially centrally in the contact communication interface, preferably, the profile is above the message area, and the dimension or size of the two interface elements are substantially equivalent. For example, the area of the profile on the display is about 40% to 120% of the area of the message area. In addition, optionally, the area of the profile may cover 20%-40% of the effective display area on the display. Likewise, this ratio range is also applicable to the display area occupied by the message area on the display. The plurality of messages may comprises at least two of the voice service message, the SMS message and the data service message; the plurality of communication networks comprise a plurality of wireless communication networks, the plurality of wireless communication networks comprise the mobile phone network and the wireless data transmission network; and the outputting step further comprises: in response to the occurrence of the latest one of at least two of the voice service message, the SMS message and the data service message, outputting only the latest one in the message area.

Optionally, in some embodiments, with the key group communicatively functionally associated with different communication networks, the method or the message outputting step therein may respectively comprise the following conditional sub-steps:

when the key group is associated with the mobile phone network, the method or the message outputting step comprises: in response to the user operation of the key group, establishing communication with the first contact via the mobile phone network to generate the voice service message and/or the SMS message. Correspondingly, the outputting step further comprises: outputting only the latest one, continuously being updated, of the voice service message and/or the SMS message in the message area; when the key group is associated with the WLAN or the mobile data network, the method or the message outputting step comprises: in response to the user operation of/on the key group, establishing communication with the first contact via the WLAN or the mobile data network to generate the data service message. Correspondingly, the outputting step further comprises: outputting only the latest one, continuously updated, of the data service message(s) in message area.

Optionally, in some embodiments, the profile of the first contact is configured substantially centrally in the communication interface for the first contact, located above the message area, the profile and the message area are equivalent in size. For example, the area of the profile on the display is approximately 60% to 90% of the area of the message area. Optionally, the method of this embodiment may further comprise the steps of: expanding the message area and optionally configuring the profile to be above the message area in an abbreviated manner; and the outputting step further comprises: collectively outputting the plurality of messages in the message area, wherein, the plurality of messages comprises at least two of the voice service message, the SMS message and the data service message.

Optionally, in some embodiments, the profile for the first contact is provided in the communication interface for the first contact, and the method further comprises the steps of: expanding the message area and optionally abbreviating the profile above the message area; and the outputting step further comprises: when the key group is associated with the mobile phone network, collectively outputting the voice service message and/or the SMS message in the message area in a temporal/chronological order; when the key group is associated with the wireless data transmission network, collectively outputting the data service message in the message area in a temporal/chronological order.

Optionally, the method of some embodiments further comprises the steps of: in response to operation of the profile or the message area, expanding the coverage of the profile and optionally reducing the message area; and, the outputting step further comprises: outputting only the latest one of the plurality of messages in the message area, wherein the plurality of messages comprises at least two of the voice service message, the SMS message and the data service message.

Optionally, the method of some embodiments further comprises the step of: when the key group is associated with the mobile phone network, integrating the voice service message and/or the SMS message to output only the latest one, continuously updated in the message area; when the key group is associated with the wireless data transmission network, outputting only the latest one, continuously updated, of the data service message in the message area.

Optionally, in some embodiments, the key group is respectively associated with the mobile phone network and the wireless data transmission network, and the method or the message outputting step further comprises: in response to the user operation of the key group, establishing communication with the first contact via the mobile phone network and the wireless data transmission network respectively to generate at least two of the voice service message, the SMS message and the data service message. Optionally, the data service message comprises one or more of the following: audio message, video message, picture message, geographic location, text message, file and data.

Optionally, as to the data service message or the SMS message, etc., while separately outputting the latest one or collectively outputting a plurality of messages in the message area, the audio message or the video message may be received by the electronic device, further in response to which audibly and/or visually (e.g., via the display, the message area in the interactive interface, a speaker) outputting the audio message or video message automatically. In this way, there is no need of manual operations by the user for the message such as the voice message. As for the text message of SMS, firstly apply the conversion of “text→voice” to it, and then audibly outputting the message content. This optional variant can also be applicable to any other embodiment of the present invention, which will not be repeated therein.

In addition, in another embodiment of the present invention there is further provided a resource providing method for an electronic device, wherein the electronic device comprises a operation interface for communication, the operation interface for communication is associated with at least one communication network, the method further comprising:

presenting a communication interface for a first contact or a first contact group on the display;

establishing communication with the first contact or the member of the first contact group via the at least one communication network to generate a plurality of messages in response to the user operation of the operation interface for communication; and

outputting a plurality of messages via the communication interface for the first contact or the first contact group.

Optionally, in some embodiments, the at least one communication network comprises a plurality of communication networks having two or more different service properties, the operation interface for communication comprises a key group virtually provided in the communication interface for the first contact and/or physically provided in the electronic device, and the key group is associated with the plurality of communication networks.

Optionally, in some embodiments, the plurality of communication networks comprise a plurality of wireless communication networks, the plurality of wireless communication networks comprise the mobile telephony network and the wireless data transmission network; the key group is respectively associated with the mobile phone network and the wireless data transmission network, and the method or the message outputting step further comprises: in response to the user operation of the key group, establishing communication with the first contact via the mobile phone network and the wireless data transmission network respectively to generate the plurality of messages.

Optionally, in some embodiments, the abovementioned plurality of messages comprise: at least two of the voice service message, the SMS message and the data service message; the step of establishing communication via the mobile phone network and the wireless data transmission network further comprises the following two sub-steps a), b):

a) when the key group is associated with/coupled to the mobile phone network, in response to the user operation of/on the key group, establishing communication with the first contact via the mobile phone network to generate the voice service message and/or the SMS message. b) when the key group is associated with/coupled to the wireless data transmission network, in response to the user operation of/on the key group, establishing communication via the wireless data transmission network with the first contact to generate the data service message.

Optionally, in some embodiments, the wireless data transmission network comprises the WLAN and/or the mobile data network, the communication interface for the first contact further comprises a switching option, and the method further comprises the step: selectively configuring the key group to be associated with the mobile phone network, the mobile data network or the WLAN according to at least one of i) a user operation of the switching option, ii) the connection status of the electronic device with the WLAN, or iii) ambient condition of available network conditions around.

In the prior art, it is of the manner of “system First” or “system desktop First” for the startup and loading process of the communication device such as a mobile phone, and the desktop interface often provides, functional differentiation oriented, a diversity of entries such as icons for a plurality of applications falling into different functional categories.

However, the resource providing method in some embodiments of the present invention follows a principle of individual Application First, for example, a contact first, which improves the accessibility of resources possibly being more of a focus for the user and preferentially provide applications with more possible interaction on the display. For example, in some embodiments, the contact interface is presented, preferentially or first of all, on the display after the electronic device is started, which constitutes a navigation method or interaction method for the contact and related information based on the user's interpersonal relationship, which may also be appreciated as a resource providing method, with the social objects of the user oriented. Configuration of the resource in the electronic device is oriented to the contact and the related information, rather than the program and its functional grouping, which reinforces the communication function or the social function based on the communication of the mobile communication device such as a smart phone to some extent. In the past and at present, diversified applications are installed in mobile phone with the evolution from functional phone to smart phone, such that the communication function of the mobile phone is weakened as a whole, and the communication function and the accessibility of and the relevant information thereof is also reduced, thereby, the operability of mobile phones is also reduced for the user who pays more attention to IM with objects in social relationship.

In a method or device according to some embodiments of present invention, a plurality of interfaces including a interface for a single contact, an application interface, or still further a collection interface for an application may be output on the display one by one in an operation mode of parallel switching, which will flatten the interaction hierarchy of the electronic device, thereby enhancing the efficiency of user interactive operation while providing a new interaction portal, interaction experience and interactive operation path for the user. Meanwhile, the technical means in these embodiments also solve the technical challenges that the smart phone, of which functional architecture is designed in to the form of “operating system+diverse applications” or “desktop+application”, lacks resource configuration basically oriented to individual function or individual object, which also leads to the inability of the users in conveniently accessing to, by simplified interaction, the application or information in which they are more interested. This kind of technical challenges is also, to some extent, caused by the mindset and technical bias on software design, followed in a long term by those skilled in the art.

In still another embodiment of the present invention, another resource providing method for an electronic device is provided, wherein the electronic device comprises an operation interface for communication and at least one interface, operation interface for communication is associated with at least one communication network, the at least one interface may be output by a display, wherein the display may be a portion of the electronic device described above. Of course, the electronic device may not comprise the display. In other words, the display may be a separate display unit independent of the electronic device, such as a TV set, the method further comprises:

step A). Outputting, by the display, a communication interface for a current contact of/in at least one user interface, the communication interface for the current contact comprising a message area for the current contact; step B). providing a profile of the current contact in the communication interface, and step C). outputting, in the message area, a plurality of messages with the current contact via the at least one communication network in response to user operation of the operation interface for communication.

Optionally, the current contact may be, for instance, the first contact, whose information (message and/or profile) related is currently loaded in the communication interface of the display for the user to interact with for communication. Of course, the current contact may be switched/instantiated to be different other contacts, such as a second contact, a third contact, and the like, with the switching operation of the communication interface by the user. Correspondingly, the communication interface for the current contact may also be different multiple communication interfaces such as a communication interface for the second contact or the communication interface for the third contact, and the like, and these communication interfaces may belong to the at least one interface.

In still another embodiment of the present invention, an information processing apparatus for use in an electronic device with a display is provided, the apparatus comprises: means for performing any one method of the plurality of methods in the present application.

In still another embodiment of present invention, the electronic device comprises a display, a touch-sensitive surface, optionally one or more sensors for detecting contact strength with the touch-sensitive surface, processor units, memory and one or more programs; the one or more programs are stored in the memory and configured to be executed by the processor units, and the one or more programs comprise instructions for performing the operation of any of the methods in the present application.

In some embodiments according to present invention, a computer readable storage medium storing instructions therein is also provided, which when executed by an electronic device with a display, a touch-sensitive surface, optionally one or more sensors for detecting contact strength with the touch-sensitive surface causes the device to perform any of the methods in present application.

In some embodiments according to present invention, a non-transitory computer readable storage medium is also provided, the non-transitory computer readable storage medium comprises one or more programs configured to be executed by the one or more processors of the electronic device, the one or more programs comprise instructions, which when executed by the one or more processors, cause the electronic device to perform any of methods in present application.

In some embodiments according to present invention, a computer program product with instructions is also provided, which causes the electronic device to perform any of the methods of the present application when the computer program product is running on the electronic device.

In some embodiments according to present invention, an electronic device is also provided, the electronic device comprises: a display, processor units and a touch-sensitive surface unit, the touch-sensitive surface unit is configured to detect a contact; wherein the processor units are coupled with the display and the touch-sensitive surface unit, and the processor units are programmed to perform any of the plurality of methods in this application.

In some embodiments according to present invention, an electronic device is also provided, the electronic device comprises: processor units, memory and one or more programs, wherein the one or more programs are stored in the memory and configured to be executed by the processor units, the one or more programs comprise instructions, which when executed by the one or more processors, cause the electronic device to perform any of methods in present application.

Meanwhile, it should be noted: although according to some embodiments of the method, electronic device or non-transitory computer readable storage medium, the electronic device comprising a display and/or a keyboard is taken as an example, in the embodiment(s), the electronic device may NOT comprise the display or the keyboard may, and the processor units are configured to perform the operations or instructions of any of the plurality of methods in present application so as to output the relevant user interface(s) by the display independent of the electronic device, or, the one or more programs comprise instructions, which when executed by the one or more processors, cause the electronic device to perform any of the plurality of methods in present application.

In some embodiments according to present invention, a system is further provided, the system comprises: one or more processors; and memory storing computer instructions therein, the computer instructions are able to implement any one of multiple methods in present application when executed the by one or more processors.

In some embodiments according to present invention, a system is further provided, the system comprises: one or more processors; and memory storing computer instructions therein, the computer instructions are able to cause the electronic device to perform any one of multiple methods in present application when executed the by one or more processors.

In some embodiments according to present invention, there is provide a graphical user interface on an electronic device with a display, a touch-sensitive surface, memory and one or more processors to execute one or more programs stored in the memory, the graphical user interface comprises interfaces displayed according to any of the methods in present application.

Optionally, the display in some embodiments comprises the touch-sensitive surface and screen.

It should be noted, if the interface element, such as the operation interface for communication or the menu item, is an software option for operator, in the step ii), if the electronic device comprises a display and the corresponding touch-sensitive surface, the “electronic device's response to the user operation of the operation interface for communication” may comprise, the response to user gestures for the interface element by the touch-sensitive surface or the touch screen of the electronic device, wherein the user gestures include but not limited to sliding, dragging, clicking, or selecting of the interface element. For example, at an electronic device having one or more processors, memory, touch-sensitive surface, and a display, “electronic device's response to user operation of the operation interface for communication ” may comprise response to user input or operation by the contact/gesture at a location on the touch-sensitive surface that corresponds to the location of the interface element such as the operation interface for communication. If the display for the electronic device is a display or monitor compatible with a personal computer, the “electronic device's response to the user operation of the operation interface for communication” may comprise response to the user operation of the interface element(s) by hardware interface such as a mouse or a keyboard, etc, wherein the user operation includes but not limited to sliding, dragging, clicking or selecting. If the display for the electronic device is a television set, the “electronic device's response to the user operation of operation interface for communication” may comprise response to the operation of the interface element(s) by hardware interface such as a remote controller or operating key in the television set, etc. wherein the user operation includes but not limited to sliding, dragging, clicking or selecting. The electronic device's response to user operation for the interface element described herein is also applicable to the response, of the electronic device, to the same or similar operation(s) in any other embodiment in response to the user operation for the interface element, which will not be described redundantly elsewhere.

In some embodiments of the resource providing methods, the plurality of operation interfaces for communication/user interface elements, such as a plurality of virtual keys are collectively provided on the communication interface for the first contact, and these keys are respectively associated with different plurality of communication networks, such as the mobile phone network, the mobile data network/WLAN, etc, thereby causing different communication channels, different communication tools or different communication means to be integrated in an identical user interface, which leads to integrating configuration of communication resources in a contact-centric manner, oriented to the simplification of the interaction operation for the process of a communication establishment between the user and the contact(s), thus causing obvious progress in the operability and accessibility of the communication resources or the message(s) in the electronic device. Improvements in these embodiments of present invention contributes to reconstructing functional architectures and cooperative relationship of technical elements including interactive interface elements in a mobile communication device, and the function of some technical features is redefined by the improvements in these embodiments of present invention, which has certain pioneering characteristics in the communication interaction and consequently a prominent substantive feature compared with function-oriented mobile phone in the prior art. To some extent, the method or device of these embodiments overcomes the traditional mindset and technical biases in resource configuration and solution design of technicians in the field of mobile communication devices, particularly smart phone. The technical biases derives from or is rooted in the desktop computer and the subsequent logical architecture dominated by “platform/operating system+functional program” in the electronic device, especially the smart phone, and the corresponding software resource providing manner with the function (group) of the application oriented.

In some embodiments of resource providing methods abovementioned, the operation interfaces for communication such as the key group provided on the first contact interface are dynamically configured, thereby selectively defining the association between the key group and the plurality of communication networks with different service properties. This association is dynamically variable and may be reconfigured automatically or according to the manual switching operation by the user. This substantially hides or shields the presence of multiple communication networks of different service properties between the user and the contacts. In this way, different communications with different service properties may be established in response to the user operation on/off the key group. For example, the voice call service, the SMS message, the data service, etc, can all be provided to the user by a single interaction interface. For the user, there is no need of switching among the communication software with different function and complex operations to obtain the operation entry for different communication functions. The user only need to interact with a single interactive interface in an identical software interface by simple operation(s) of the mode switching option or the key group (or called communication options, communication option group, etc), so as to access almost all the available communication resources in the electronic device, thus improving the accessibility of the communication resource for the user and the operability of the electronic device accessing to the communication networks.

Additionally, not only the function of instant messaging and mobile phone communication are integrated into the single program, but also the information such as the mobile phone number and the identification of the instant communication application corresponding to an identical contact in the communication network(s)with different service properties can be integrated into the single program. By this way, only a single address book(or named as Contacts application) needs to be established in the electronic device, and it is not necessary to redundantly store information such as the address book, the communication record and the like for an identical contact respectively in different software(s) with different communication functions. The user does not have to separately access to these scattered and redundant information. Moreover, the key group is communicatively functionally associated with the mobile phone number and the identification directly, generally, the user does not have to repeat the input of the mobile phone number or login by the identification, but establishing communication of corresponding service properties via one-key operation in the key group instead. The user is shielded from the presence of contact information such as the mobile phone number and the identification, which is contact centric or may also be regarded as a configuration method for communication resource and human-computer interaction oriented to user interaction experience, thereby simplifying the interaction logic of communication between user and contact and making the contact(s) reachable by only a touch or click, with a shorter logical distance between user and available communication network resources.

The key group always retains formal consistency while being selectively associated, particularly automatically, with different communication networks dynamically, thus causing the electronic device, although with multiple different available network, to provide the user with consistent interface element(s), so as to further hide the presence of the plurality of communication networks with the contact(s). In some embodiments, in the communication with contact(s) by the SMS service, the text content of the SMS message and the voice signal are converted to each other via a microphone and a speaker of the electronic device, which is equivalent to or the same with, in terms of user interaction, receiving and sending a voice message of the data service. In this way, the user can not perceive the variation of the communication network currently used or the corresponding service properties, the electronic device provides a normalized interaction process and interaction experience, thus improving the operability of the software and accessibility of related information.

In some embodiments of the resource providing method, one or more of the voice service message, the SMS message, and the data service message are integrated and output to the display with only the latest one in the message area, moreover continuously updating and outputting, in the message area, the latest one that just occurred, in response to the occurrence of the latest one of the plurality of the messages abovementioned. This focuses more on the rounds of message incoming and outgoing during communication interactions with the information revealed in the manner of “one piece of information at a time”. The unique presence of a single message may be applied with a large font, which facilitates the user to identify and obtain the content of the message, thus improving the accessibility of the communication application and related information and especially the efficiency of accessing to message(s) latest occurred. Moreover, by continuously updating and outputting only the latest message the most recent one, often deserving more concern, may be directly accessed, without having to identify it among the plurality of messages. This improves the operability of the latest occurred message being accessed by the user, so as to further improve the acquirability of the latest occurred message for the user.

Therefore, compared to collectively displaying the plurality of messages, if the message area is only used to display a single message, not only the area occupied by the message area on the contact interface can be relatively narrowed, but also the message in the message area can be easily recognized. This strikes a balance between a pair of contradictory factors: the message area and the font size of the messages therein needs to be enlarged for ease of recognition, on the contrary, the larger message area accommodates too many, or somewhat messy, message records, meanwhile shrinking the display space for an individual message and consequently reducing its recognizability. Thus, the technical means in some embodiments of the present invention solve the long felt but unsolved needs in the provision of interface resources, which may come from the technical bias of those skilled in the art, to some extent.

Additionally, the profile of the contact such as icon, avatar and the like are separately configured outside the message area, for example, above the message area, and are not provided within the message area, thereby further reducing the occupation of the effective area in the message area and improving the recognizability of the message content in the message area.

Moreover, a larger area for displaying the profile is configured on the contact interface, for example the size of the profile may be comparable to the size of the message area, and by means of the relatively large profile, the identity of the current contact may be easily recognized by the user, in other words, the recognizability of the sender or recipient of the current message is improved.

Additionally, this is not only applicable to a single contact interface, but also applicable to a interface for the contact group in combination with other means, which may be referred to the description in other related embodiments. Moreover, since the number of messages in the message area of the contact group is more and messier, it would further improve the recognizability of the message content in the message area of the contact group as well as simplifying the entire interface for the contact group in the case that the message area is only used for displaying a single message and the profile of the contact group is configured outside the message area.

Additionally, if two or three items of the voice service message, the SMS message and the data service message are integrated and of which the latest one is output by the contact interface, the user do not have to separately access to different communication applications to obtain the message(s) with different service properties, thereby further improving the accessibility of message(s) in the electronic device and the operability of the electronic device.

In some embodiments of the method for providing the interface resource, in a UI switching process for the electronic device, the plurality of application interfaces including the application interface for communication are configured as a parallel switchable mode by the display. Preferably, the conventional operating systems, such as Android, may be customized to integrate components related to the interface for communication application into the operating system of the electronic device to form a single program in system-level. And the components related to the contact interface, or called interface for communication application, may be used as an operating system user interface (UI) such that the component of application communication runs exclusively on the display of the electronic device, which means: the application/communication interface for the contact may be an entire page and occupy the whole display for the electronic device. Correspondingly, the single program is automatically run in the startup of the electronic device, and the plurality of interfaces such as contact communication interfaces configured in the electronic device are presented to the user the first time after the startup is completed, located at the top level of a software interaction hierarchy of the electronic device. The multiple interfaces can occupy display resources of the electronic device in a switchable manner. These communication interfaces for the contact is directly loaded on the top layer of the interaction hierarchy of the software system in the electronic device after the electronic device is started, which is equivalently in place of the normal desktop of the common operating system, thereby further increasing the accessibility of related communication resources and the message(s). Moreover, the user interface elements or the key group for communication configured on a diversity of application interfaces may be respectively adapted for the function of the respective application on each of the diversity of interfaces, or may be consistent, in terms of interaction, layout, and sensory, among the plurality of interfaces for a plurality of applications with different functions respectively to some extent, which follows the consistency of the user experience to a certain extent, thereby enhancing the operability, by UI, of the applications with communication function.

### BRIEF DESCRIPTION OF THE DRAWINGS

In order to illustrate the embodiments of present invention or the technical solutions in the prior art more clearly, a brief description of the drawings used in the embodiments or the prior art description will be briefly described below. Apparently, the drawings in the following description are certain embodiments of the present invention, and other drawings can be obtained from those skilled in the art without any creative work.

FIG. 1a is a schematic structural diagram of a physical keyboard according to one embodiment;

FIG. 1b is a schematic diagram of an operation process corresponding to the physical keyboard provided by the embodiment shown in FIG. 1a;

FIG. 2a is a schematic structural diagram of another physical keyboard according to an embodiment of the present invention;

FIG. 2b is a schematic diagram of an operation process corresponding to the physical keyboard provided by the embodiment shown in FIG. 2a,

FIG. 3 is a schematic structural diagram of an electronic device according to one embodiment;

FIG. 4 is a schematic structural diagram of another electronic device according to one embodiment;

FIG. 5 is a schematic structural diagram of another electronic device according to one embodiment;

FIG. 6 is a schematic structural diagram of another electronic device according to one embodiment;

FIG. 7 is a systematic structural diagram for establishing communication with a contact through a mobile terminal in the prior art;

FIG. 8 is a schematic diagram of a user interface in a resource providing method according to another embodiment of the present invention;

FIG. 9 is a schematic flow chart of a method for providing interface element(s) according to one embodiment;

FIG. 10 is a schematic flowchart diagram of a resource providing method for an electronic device according to an embodiment of the present invention;

FIG. 11 is a schematic diagram of correspondence between at least one interface configured in an electronic device and at least one option presented on the display according to one embodiment;

FIG. 12A and FIG. 12B are schematic diagrams of switching between two interfaces configured in an electronic device according to an embodiment of the present invention;

FIG. 13A˜FIG. 13I are schematic diagrams of some menu items and the associated applications or interfaces therewith configured in an electronic device, according to an embodiment;

FIG. 14A˜FIG. 14B are schematic diagrams of communication mode of instant communication and mode by mobile telephony network according to an embodiment of the invention;

FIG. 15A˜FIG. 15C are schematic diagrams showing a first contact communication interface operable to switch between “single card mode” and a “communication record mode” provided by the method of the embodiment of the present invention;

FIG. 16 is a front view showing the structure of a terminal communication device comprising a cradle and a first mobile terminal separately arranged according to an embodiment;

FIG. 17 is a schematic structural diagram of still another physical keyboard according to an embodiment of the present invention;

FIG. 18A˜FIG. 18E are schematic diagrams of an album application interface according to an embodiment of the present invention;

FIG. 19a is a schematic diagram of a specific structure of an optional implementation of the toggle button shown in FIG. 17;

FIG. 19b is a schematic diagram of an operation process corresponding to the toggle key provided in the embodiment shown in FIG. 17;

FIG. 20 is a schematic structural diagram of still another physical keyboard according to an embodiment of the present invention;

FIG. 21 is a schematic structural diagram of a direction key for selecting a contact according to an embodiment of the present invention;

FIG. 22 is a schematic flowchart diagram of a resource providing method according to an embodiment of the present invention;

FIG. 23 illustrates a flowchart diagram of a resource providing method according to an embodiment of the present invention;

FIG. 24 illustrates a schematic diagram of concurrently presenting multiple interactive interfaces on a foldable display of an electronic device according to one embodiment.

### DETAILED DESCRIPTION

To make the objectives, technical solutions, and advantages of the present invention more clear, the following clearly and completely describes the technical solutions according to the embodiments of the present invention with reference to the accompanying drawings in the embodiments of the present invention. Apparently, the embodiments described are a part of the embodiments of the invention, and not all of the embodiments. All other embodiments obtained by those skilled in the art based on the embodiments of the present invention without creative efforts are within the scope of the present invention. The terms in the embodiments of the present invention are merely for the purpose of describing particular embodiments and are not intended to limit the invention. The singular forms “a”, “said”, “the” employed in the embodiments of the invention and attached claims generally designed to contain the plural forms unless the context clearly indicates other meanings, “a plurality of” generally contains at least two. It should be appreciated that the term “and/or” employed herein is merely an associated relationship describing the associated object, indicating that there may be three relationships, for example, A and/or B, which may indicate three cases that A exists separately, while A and B co-exist, or B exists separately. Additionally, the character “/” in this invention generally indicates an “or” relationship for the contextual associated objects.

The word “if” as used herein may be interpreted to mean “while” or “when” or “in response to determining” or “in response to detecting”, which depends on the context. Similarly, “while” or “when” in some embodiments may also be interpreted as a conditional assumption such as “if” or “as”, which depends on the context. Similarly, the phrase “if (conditions or events stated)”, “in response to (conditions or events stated)”, “if determined” or “if detected (conditions or events stated)” may be interpreted as “when determined” or “in response to determination” or “when detecting (stated condition or event)” or “in response to detecting (stated condition or event)”, which depends on the context. It should also be noted that the terms “comprising”, “including” or any other variations thereof intended to encompass a non-exclusive inclusion, such that a commodity or system that comprises a series of elements comprises not only those elements, but also other elements not explicitly listed, or elements that are inherent to such goods or systems. In the absence of more limitations, elements limited by the phrase “comprising a . . . ” do not exclude the presence of additional identical elements in the item or system that comprises those elements.

Embodiments for the electronic devices, user interfaces for such devices, and associated processes for using such devices are described. In some embodiments, the device is a portable communication device (such as a mobile phone) that also comprises other functions, such as PDA and/or music player functionality. Exemplary embodiments of portable multi-function devices comprise but not limited to other portable electronic devices such as laptop computers or tablets computers with touch-sensitive surfaces (e.g., touch screen displays and/or touch pads). It should also be appreciated that in some embodiments, the device is not a portable communication device or communication apparatus, but a desktop computer with a touch-sensitive surface (e.g., a touch screen display and/or a touch pad). In some embodiments discussed below, an electronic device with a display and a touch-sensitive surface is described. However, it should be appreciated that the computing device may comprise one or more other device with physical user interface, such as a physical keyboard, a mouse, and/or a joystick.

In addition to communication applications such as telephone applications, video conferencing applications or instant messaging applications, the device may also support a variety of applications, such as one or more of the following applications: note taking application, drawing application, presentation application, word processing application, health management application, game application, email application, exercise support application, photo management application, digital camera application, digital video recorder application, web browsing application, digital music player application and/or digital video player applications. Additionally, the sequence of steps in the following embodiments for the method is merely an example and is not strictly limited.

Some relatively independent aspects or several relatively independent modules of some embodiments are respectively introduced under the headlines of the present application, such as “configuration of Interface and main interface”, “Integrated interactive interface”, “Some embodiments of the first resource providing method”, “Key/button arrangement and its modality and function”, “method and device for providing graphical element(s) cross interfaces”, “Single card display”, “ Integrating and storing a plurality of communication network messages for contacts in a single program”, “Electronic device with a detachable base”, “integrated communication by multiple networks”, and more variations can be made by means of any combination of these modules. Only a part of the variations is schematically illustrated in this application, which does not preclude a more diverse combination between the above several modules, or between the several modules and other embodiments of the invention. For example, all embodiments under the headline of “Integrated interactive Interface”, “Some embodiments of the first resource providing method” or the like and the modifications of the modules and module variations involved therein may be correspondingly applicable to other embodiments. The possibility of combination among the embodiments or among the modules of the embodiments will not be repeated elsewhere.

Interface and Main Interface Configuration

The inventor has found that the software installed in the electronic device and the communication device of the prior art is diversified, and each software has one information separately stored, such as contact information and contact group information for the instant messaging software installed in the cell phone and the contact information stored in the built-in dialing application, etc, alternatively, the message(s) generated by the short message service, the call record generated by the dialing application, and the message(s) of data service type generated by the instant messaging software are also respectively stored in individual application. The information stored in these different applications is redundant in the mobile phone, and the user often has to access to different software applications that are functionally classified through different interaction portals. Consequently, there emerges a requirement to integrate software resources such as a plurality of interactive portal interface elements as well as functionality and utility of front-end and back-end and communication resources such as capacity of the communication networks and related information, thereby improving accessibility to the message(s) and application information in the cell phone, and accessibility of applications in different functional categories and related information, such as applications within an electronic device, communication contact, separately recorded or in contact group. Meanwhile, there also exists a requirement to simplify the hierarchical interaction of the electronic device or the communication device, such as a mobile phone, loaded with diverse application software and to enhance the operability of the electronic device or the communication device. anticipation and corresponding solutions for the above technical challenges or potential requirement are at least partially absent in the prior art.

Furthermore, in the interaction of the electronic device including the integration and provision of the redundant information for a single contact to electronic device such as a cell phone, there is missing a high operability and accessibility to facilitate the user to access to the message(s) with the single contact or establish the communication with the single contact by the single contact interface.

In one embodiment of the present invention, a resource providing method for an electronic device is provided, wherein the electronic device comprises an operation interface for communication associated with at least one communication network, and the electronic device further comprises at least one interface that may be output by a display. The resource providing method according to the embodiment comprises two steps: step 1) presenting a communication interface for a first contact group of at least one interface on the display, wherein the communication interface for the first contact group comprises a message area; step 2), outputting, by the message area, a plurality of messages with the first contact group via the at least one communication network in response to a user operation of the operation interface for communication.

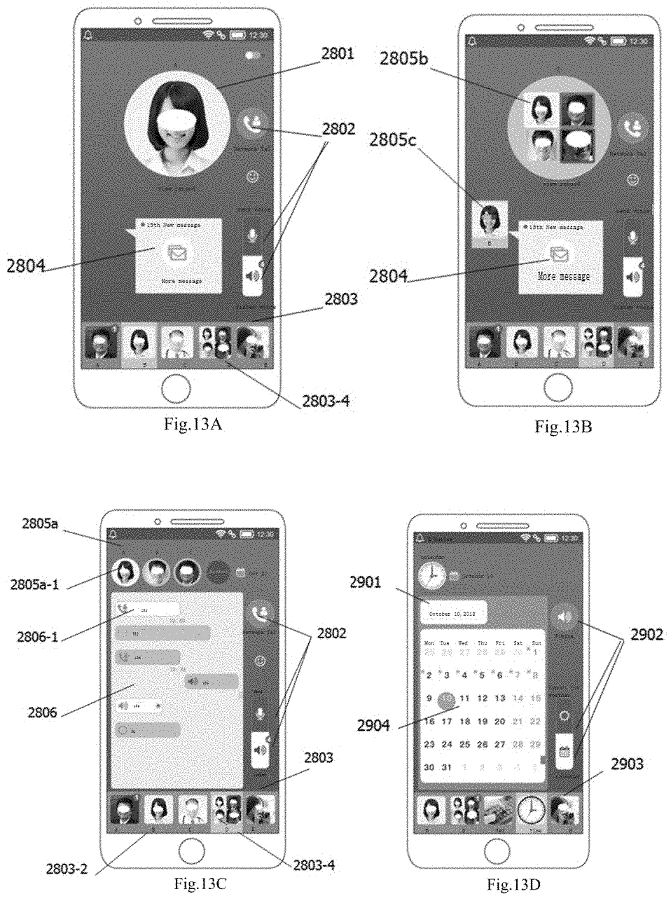

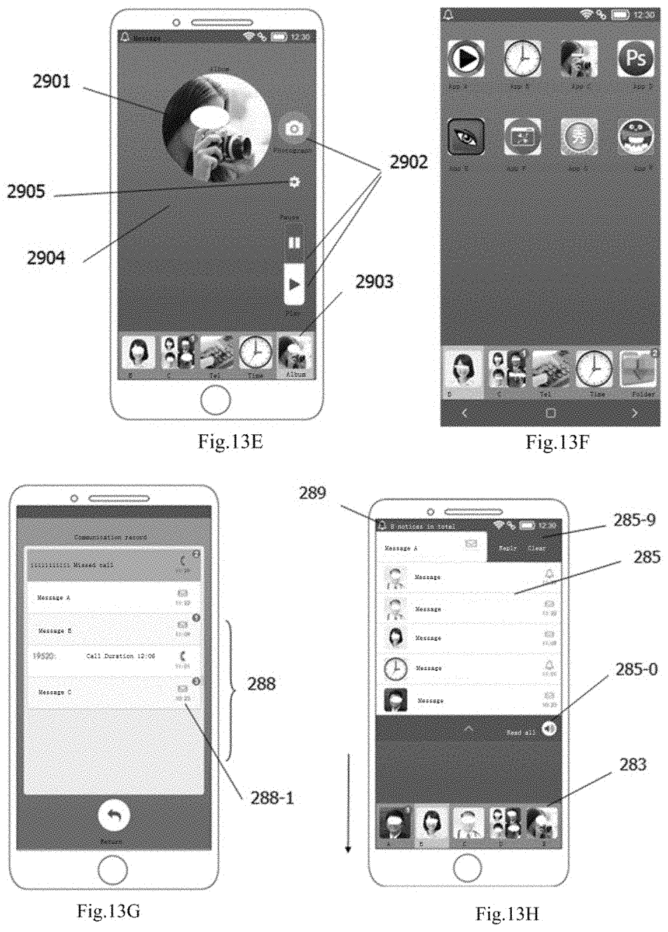

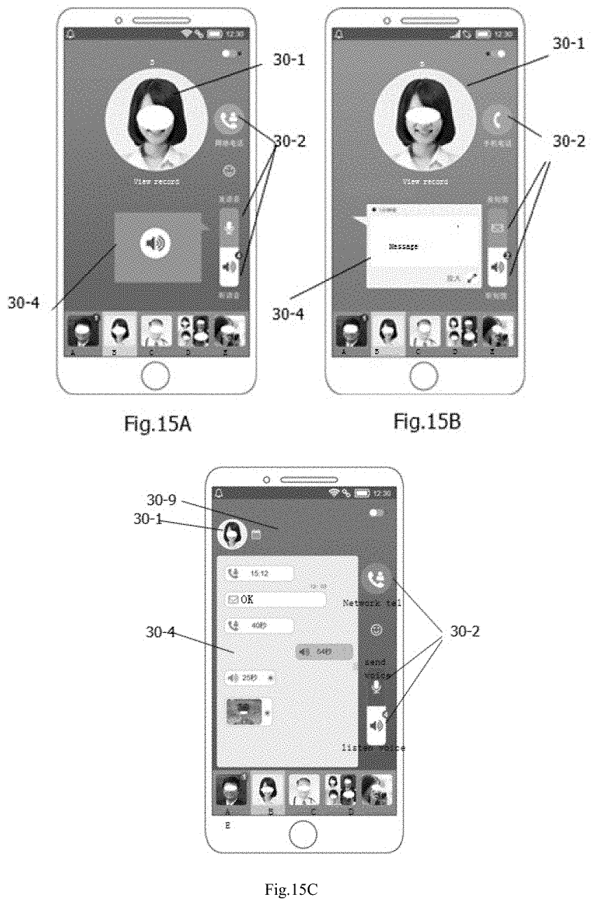

Optionally, the first contact group in the embodiment may comprise only a single contact, or may also comprise two or more contacts. In the former case, it is equivalent to perform the communication interaction between the user of the electronic device and the first contact. For this case, it may be referred to FIG. 13C and FIG. 15C and the related embodiments, FIG. 13B and FIG. 15A and related embodiments for ease of understanding.

Generally, in the method according to some embodiments of the present invention, including those relevant embodiments under the headlines of “Integrated interactive interface”, “Single card mode”, “Communication by multiple networks integrated”, the communication between user of electronic device and the first contact is taken as an example to illustrate the related resource providing method, the configuration method of the communication interface for the first contact, or the electronic device. However, it can be appreciated: the following method or the device of the embodiment for the case between the user and the first contact is also applicable to the communication interaction between the user and the first contact group, and the resource providing method involved in the communication interaction, the configuration method of a communication interface for the first contact group, or the electronic device. Vice versa, the method or the device of the embodiment for the case between the user and the first contact group is also applicable to the communication interaction between the user and the first contact, and the resource providing method involved in the communication interaction, the configuration method of a communication interface for the first contact, or the electronic device.

Optionally, in general, In the method according to some embodiments of the present invention, including those relevant embodiments under the headlines of “Integrated interactive interface”, “Single card mode”, “Communication by multiple networks integrated”, the operation interface for communication configured in the electronic device, which may also be referred to as communication interface element, may be implemented in hardware or software manner, in some methods according to some embodiments of the invention, the operation interface for communication may be a key group, in the form of software, virtually provided on the communication interface for the first contact or a key group provided in a physical form on the electronic device, the functions of the above two key groups are correspondent and may be separately configured in the software and the hardware of the electronic device, or may be concurrently configured to the electronic device for the user to freely choose to perform the communication interaction with the electronic device, by means of hardware or software. Specifically, the former virtual key group is generally virtual key, button on the communication interface, and the latter physical key group may be configured, as a hardware part, on the housing of the electronic device. Both of these two types of human-machine interfaces are operable by the user to establish the communication. The at least one message may correspond to the messages with the same service property, such as the messages of the data service, or may also correspond to the messages with a plurality of different service properties.

The resource providing method according to the embodiment of the present invention may be run independently or in combination with an application in some electronic devices or communication devices. In some embodiments, a mobile phone, a smart phone, a smart mobile device, or the like will be taken as an example for illustration.

The resource providing method according to the embodiment of the present invention provides a resource configuration by interface in an integrating manner, centralized on the user and its contacts with user interaction oriented. Moreover, in some embodiments described below, some simplified user interfaces (UI) and related functional components are constructed. In other words, the interactive operation and corresponding functions of the electronic device and the communication device such as the cell phone are redefined relative to the prior art, and interaction operation hierarchy is simplified oriented to the user and the contacts in his/her relationship, with the wireless data transmission network and the Internet as main communication media, thereby enabling the electronic device with a high operability and the ease of use for the user.

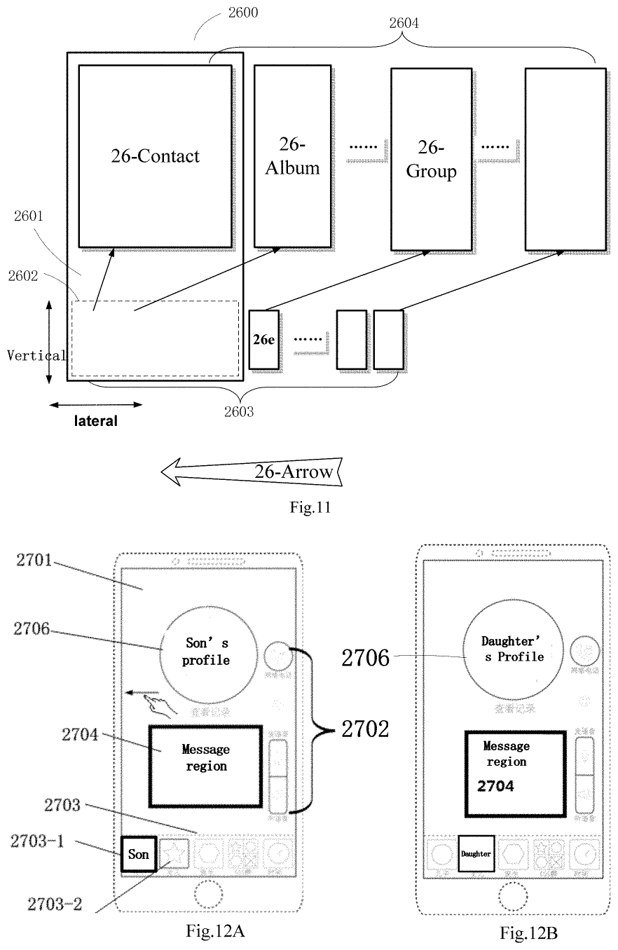

FIG. 10 is a flow chart showing a resource providing method for an electronic device according to an embodiment of the present invention, FIG. 11 is a schematic diagram of correspondence between the at least one interface configured in an electronic device and the at least one option presented on the display according to an embodiment of the present invention. The method according to some embodiments of the present invention including those relevant embodiments under the headlines of “single card mode” and “Communication by multiple networks integrated” will be described below with reference to FIG. 10 and FIG. 11, and the resource providing method may comprise three steps: Step 2501, step 2502, and step 2503.

In step 2501, a communication interface 26-Contact for the first contact in at least one interface 2604 is presented on the display, wherein the communication interface for the first contact comprises a message area (not shown in the figure). In step 2502, a plurality of messages with the first contact via the at least one communication network is output by the message area in response to the user operation of/on the operation interface for communication (not shown in the figure). The plurality of messages may comprise audio message, or video message, these messages may be recorded as communication record in the message area, and may be output by the message area for user to browse or access. Alternatively, the audio message may be audibly output to the speaker in response to an accessing operation of the audio message by the user by the message area.

In step 2503, at least one option 2603 is provided on the display, the at least one option 2603 is configured in thumbnail and respectively associated with at least one interface 2604.

Optionally, in some embodiments described above or below, the at least one interface 2604 is configurable by user, or may be generated/activated by the configuration operation from the user. The at least one interface may be available by the display for an electronic device. Correspondingly, in the method of relevant embodiments, prior to the step of presenting the communication interface for the first contact, the method further comprises the step of: configuring at least one interface 2604 in the electronic device according to user operation. Alternatively, prior to the step of presenting the communication interface for the first contact, the method further comprises the step of: configuring, generating or activating the at least one interface 2604 according to the configuration operation. Optionally, the user operation(s) comprise the configuring operations such as adding, setting, deleting or the like for the at least one interface or at least one resource with which the at least one interface is associated. The above user operations may be performed locally by the display of the electronic device, or performed remotely by wired/wireless connections between other devices and the electronic devices in some embodiments of the present invention. In addition to the general configuration of resources in applications such as contact information or address books associated with the communication application, the configuration of one or more options/resources in the electronic device in response to the user operations may also be detailed in the description of the related embodiments under the headline of “Configuration of resources or options in the electronic device”.

Optionally, in the method according to some embodiments of the present invention, including those relevant embodiments under the headlines of “Single card mode”, “Integrated Communication by multiple networks”, the association relationship between the at least one option 2603 and the at least one interface 2604 may be embodied as: the at least one option 2603 is in one-to-one correspondence with the at least one interface 2604, and a corresponding interface in the at least one interface 2604 abovementioned may output by the display in response to the user operation(s) on the at least one option 2603 respectively. The correspondence of at least one option 2603 and the at least one interface 2604 may be referred to the association shown by the arrow(s) in FIG. 11, and the one or more interfaces 2604 may be substantially independent of each other.

Optionally, the method may further comprise the step of enabling said first communication UI and/or said first option in said electronic device in response to detecting an operation for adding the first contact by the user; or the step of updating said first communication UI and/or said first option in said electronic device in response to detecting an operation for updating the first contact by the user, wherein said first communication UI and/or said first option are optionally configured in a sequence in the electronic device and will be switched to output in that sequence by the display in response to the user's switching operation. This means: the information for the first contact may be configured in the device on demand In other words, with factory settings, there may be NO information for the first contact, when the electronic device is configured, locally or remotely, the information may be added and stored in the device. And the information for the first contact may include the phone number, communication UI and the corresponding option for the first contact.

Additionally, since the at least one option represents, in thumbnail, the at least one interface respectively, may more options may be present, in the form of the abbreviated menu item, on the present interface at a smaller scale for the user, such as contacts, applications, etc. Therefore, the user can also become globally aware of other available options by the current interface, such as communication contacts, applications, etc., which play a role of navigation on selecting and locating in a plurality of application options configured by the user in the electronic device. Of course, optionally, the programs in the electronic device may also be executed by a processor unit to: cancel the presentation of the at least one option in response to a real-time response event occurring to the electronic device. When a real-time response event occurs, there is no need for navigation by a plurality of options at the bottom of the display, canceling the displaying of the plurality of options may also provide the real-time response event with a larger screen for display space. When the online video or audio call is over, the plurality of options for providing navigation as described above may be restored around the display. Generally, the real-time response event comprises an event that does not allow the user to make a deferred response such as an online call, while the short message is not a real-time response event, because the processing of which may be postponed.

Of course, it should be appreciated that other interfaces may be configured in the electronic device in addition to at least one interface 2604. These other interfaces do not have corresponding options in at least one option 2603, and vice versa. But this does not prevent/hinder the association a further one-to-one correspondence between at least one interface 2604 and at least one option 2603.

Herein, it should be noted that the related resources of the at least one interface 2604 are configured in the electronic device or configured in a remote server, the at least one option 2603 may be, optionally, regarded as an icon similar to a shortcut, which is revealed on the display for the user to select. Meanwhile, the at least one option 2603 points to or is associated with the corresponding resources. Thus, when the user selects the at least one option 2603 on the display, the electronic device will invoke or run the relevant resources associated with the at least one option 2603 to output the at least one interface 2604 corresponding to the at least one option 2603 by the display. Wherein the related resources corresponding to each of the at least one option 2603 may also be referred to as at least one object (not shown in the figure). The at least one object is optionally an executable program resource located in a background or remote server of the electronic device, for example, a first option in the at least one option 2603 may comprise addressing information such as a local storage path or a network address for the associated resource. When the first option in the at least one option 2603, for example the first contact icon is selected by the user, correspondingly, the first object in the at least one object, for example, related information for the first contact or the addressed executable resource is loaded to output a first interface in the at least one interface 2604 by the display, such as the communication interface for the first contact. When the first option is an icon for the first contact and the corresponding first object is the communication program, the first option may further comprise a communication means for the first contact, namely, the first option is associated with the communication means for the first contact, such as a phone number or a unique identification (ID) for instant messaging, which is also applicable to other embodiments. Of course, optionally, the phone number can also be used as the identification code or login account of the instant messaging if the digit sequence of phone number is unique, and both of identification code and login number are formally the same but are respectively employed by the electronic device to establish communication via different communication networks. The output of the at least one interface 2604 by the display may be triggered by the user selecting operation of the at least one option 2603 or the user switching operation of the user interface such as the communication interface, the application interface, or the like.

To sum up, optionally, the at least one option configured in the electronic device comprises one or more of the contact option, the contact group option, a subscribe option, and the application option, wherein the options for the applications comprise program names and/or program icons. The options for a contact comprise images and/or short names of the contact. Still further, the contact option comprises running address of the communication application associated with the contact, contact information for the contact, and at least one of the following: name, identity, relationship with a user of the second terminal, and title and nickname of the user of the second terminal. The application option also comprises the running address of the associated application, remote or local.

The at least one option 2603 has a certain order of arrangement on the display, which is formed by the user adding to or sorting the at least one option 2603 by interaction with the electronic device, or the order of the at least one option 2603 is set by backdoor program logged in from a server or another remote electronic device. Whether the at least one option 2603 is provided to the user by, for example the bottom area of the display or not, the outputting order of at least one object on the display may be independently configured. For instance, after the first interface corresponding to the first object, for example the interface 26-Contact, is output by the display, other interfaces may be sequentially output according to the predetermined order described above in response to repeated switching operation by the user such as sliding in single direction along the arrow 26-Arrow in the figure, by the interface outputting area on the middle of the display. The at least one interface 2604 is in one-to-one correspondence with the at least one object stored locally or remotely. Optionally, the at least one object may comprise at least one contact information, the at least one interface may also comprise at least one contact interface corresponding to the at least one contact information. Herein, the relationship between the configuration order of the at least one option on the display, the possible configuration order of the at least one object and the at least one interface, is also applicable to the method or device of some embodiments described below.

At least one interface which may be output by the display 2601 of the electronic device 2600, such as the interface 26-Contact, the interface 26-Album, the interface 26-Group, etc., comes from the resource of at least one object configured in the electronic device and visually represents the at least one object (not shown in the Figure) on the display 2601. And the at least one object may comprise but not limited to: the contact information for communication, the contact group information, various applications, for instance Mini program built in the system such as an album, or access entry information/link information for an independent third-party program, etc. These one or more options may be output by the display 2601 respectively in the form of corresponding interfaces, such as the communication interface for the first contact 26-Contact, the album application interface 26-Album, the contact group communication interface 26-Group, and the like.

Optionally, in the method according to some embodiments of the present invention, including those relevant embodiments under the headlines of “Integrated interactive interface”, “Single card mode”, “Communication by multiple networks integrated”, the method may further comprise the step of: presenting the at least one option 2603 on the display 2601 portion by portion in response to a switching operation for the at least one option 2603 by the user. It should be appreciated that the switching operation for the at least one option 2603 may comprise a sliding gesture or the like for the region in which the at least one option 2603 is located.

Optionally, in the method according to some embodiments of the present invention, including those relevant embodiments under the headlines of “Single card mode”, “Communication by multiple networks integrated”, as shown in FIG. 11, the at least one option 2603 is configured in a single row at the top/bottom of the display, or in a single column in the side of the display, wherein the lateral strip area occupied by the abovementioned option(s) in single row on the display may be referred to as menu area, or a single row area 2602. Taking the at least one option 2603 arranged in a single row as an example, as shown in FIG. 11, the single row option(s) in the single row are laterally configured at the bottom of the display, the method of this embodiment further comprises the step of: moving to present the at least one option 2603 portion by portion through the single row area 2602 in response to the switching operation of the single row area 2602 by user. Further optionally, option area 2602 is a global menu window retained across the interface, which is employed to accommodate menu items and is always kept at the bottom of the display or the current interface.

Optionally, in the method according to some embodiments of the present invention, including those relevant embodiments under the headlines of “Single card mode”, “Communication by multiple networks integrated”, the at least one option 2603 may be substantially equally divided into a plurality of groups, a first group of option(s) are firstly configured in a single row at the bottom of the display, and the plurality of groups of option(s) are sequentially moved along the direction of the user operation, such as sliding, sliding through the single row area 2602 in order for presentation to the user in response to the switching operation of the single row area 2602 by user. As shown in the FIG. 11, the first group of options comprise a first option 26a, a second option 26b, a third option 26c, and a fourth option 26d, wherein the first option 26a corresponds to the communication interface 26-Contact for the first contact, the second option 26b corresponds to the album application interface 26-Album, the third option 26c and the fourth option 26d also correspond to two interfaces (not shown in the figure) of the at least one interface 2604 respectively, a fifth option 26e corresponds to the group communication interface 26-Group. The first group of options are configured in the single row area 2602 at the bottom of the display; or configured in the single column (not shown in the figure) in the side of the display, and a second group of options in/among the at least one option is switched to present in the single row area in response to a switching operation of the first group of options by user, the second group of options comprise a fifth option 26e and subsequent three options (not shown in the figure). The switching operation herein may be a left or right sliding operation, which will not be repeated below. Specifically, the step of switching to present the first group of options and the second group of options in the at least one option through the single row area may comprise: collectively moving the first option 26a, the second option 26b, the third option 26c and the fourth option 26d along the user sliding direction indicated by the directional arrow 26-Arrow in FIG. 11, subsequently presenting the second group of options, that is, the fifth option 26e and the three options subsequent thereto. In another aspect, the step of switching to present the first group of options and the second group of options in the at least one option by the single row area may further comprise: moving the first option 26a, the second option 26b, the third option 26c and the fourth option 26d in the direction of the sliding indicated by the arrow 26-Arrow to cancel the presentation of the first option 26a, the second option 26b, the third option 26c, and the fourth option 26d one by one on the edge of the display, and subsequent to the first group of options, moving the second group of options, headed by the fifth option 26e, into the single line area 2602 portion by portion. In still another aspect, the step of switching to present the first group of options and the second group of options in the at least one option by the single row area may further comprise: sequentially moving, in visual effect, the first option 26a, the second option 26b, the third option 26c, and the fourth option 26d out of the display area of the display in the direction of the sliding operation indicated by the arrow 26-Arrow, and following the first group of options to move the second group of options led by fifth option 26e into the single row area 2602.

Of course, the option 26d is the last one of the first group of options, if the current interface is the interface corresponding to the option 26d and the option 26d is formally differentiating as the current option, then in response to the switching operation of left sliding by user for the communication interface or the application interface to which the option 26d corresponds, the electronic device may be programmed to switch to present the second group of options of at least one option in the single row area, and formally differentiate the first option 26e of the second group as the current option, and to load the communication interface or the application interface corresponding to the option 26e is loaded in the UI.

It is worth being noted that: in the method according to some embodiments of the present invention, including those relevant embodiments under the headlines of “Single card mode”, “Communication by multiple networks integrated”, a plurality of options may be arranged in a single row and presented, portion by portion, on the display in a slidable/scrollable manner, wherein the speed of the possible sliding may correspond to the speed of the user gesture, and the sliding unit is a portion or a group of the plurality of options, which allows the user to clearly distinguish the next group of options(to be browsed/viewed) and the last group of options already browsed, thereby regularly looking through all the options. Meanwhile, the abovementioned a group/portion of the options may comprise 1-10 options, optionally 3-6 for a general cell phone, such as 4 in the abovementioned embodiment. For a mobile terminal equipped with a larger display such as a tablet, each group of options or each portion of options may comprise a greater number of options. Of course, the number of options included in each section or each group is preferably the same.

Optionally, the single row area 2602 may be the area in which the plurality of options configured in the single row at the top or bottom of the display is located. Alternatively, the single row area 2602 may also be appreciated as an area within the outline of pixels or location covered by a plurality of options on the display, substantially invariable with changes of the plurality of options. For example, the single row area 2602 may be a lateral strip area at the bottom of the display, the width of which is about 0.5 cm to 3.5 cm in the longitudinal direction (as indicated by the arrow in FIG. 11), preferably 1.5 cm to 2 cm. The single row area 2602 is laterally located at the bottom of the display, which doesn't occupy the main area for interaction or display on the display and facilitate the user operation for handheld device without interfering with the main interaction behavior by user. By the single row area 2602, the user may apply an operation, including switching operation such as sliding, to one or more options located at the bottom of the display, and the effect by a switching operation on the main area for interaction/display and the effect by a switching operation on the single row area is different, which is detailed in the relevant embodiments under the headline of “Interface and Main Interface Configuration”. The abovementioned “main display area for display” or “main area for interaction” may comprise a certain portion of the communication interface for the first contact, or a portion excluding the menu area or the single row/single row area on the display.

Optionally, the single row area 2602 may also be explicitly or implicitly used as a menu area, correspondingly, the at least one option 26a, 26b, 26c, 26d may also be defined as four menu items accommodated in the menu area. Moreover, it should be appreciated that the menu area provided herein on the display as well as interface elements configured on the display of method or device in some embodiments described below is, virtual and not physical, which will not be repeated. The embodiments herein are more of the case of moving to present multiple options in the menu area at the electronic device in response to the operation gesture on the menu area by user, such as scrolling/sliding. As a variant, the electronic device may also move to present the multiple options in the menu area in response to a user operation of physical keys for direction configured in the electronic device, specific variations may be referred to the description of the embodiment under the headline of “Electronic device with a detachable base” of the present application.

It may be appreciated that the movement is relative. Although, from a sensory perspective, the serials of options 26a, 26b, 26c, 26d are moved for presentation along the switching operation in the menu area in response to the switching operation by user, which may also be relatively considered as the case that the menu area acts as a slidable window, and moves relative to the serials of options portion by portion in the direction opposite to the switching operation, so as to present the serials of options. Correspondingly, in another aspect of the above embodiment, the menu area or the single row area 2602 laterally configured at the bottom of the display, may be regarded as a sliding window with respect to the plurality of options, first of all, the first portion of the plurality of options, or the front four options 26a, 26b, 26c, 26d are queued to the sliding window, and then the electronic device may move to present the first four options 26a, 26b, 26c, 26d and subsequent other options headed by the option 26e through the sliding window in response to the user switching operation for the sliding window. Of course, the option 26e and its subsequent options are also presented in the form of a queue portion by portion through the sliding window, and these options 26a, 26b, 26c, 26d, 26e are queued to the menu area or the single row area 2602 at the bottom of the display in a certain order.

Optionally, the user switching operation for the sliding window may be a sliding operation for the single row area 2602, and the size of the sliding window is equal to the step of the sliding window, each of which is 3-6 options, for example, 4 contact options or 5 application options, etc.

The abbreviated menu items are configured at the bottom of the display in the method according to some embodiments of the present invention, including those relevant embodiments under the headlines of “Integrated interactive interface”, “Single card mode”, “Communication by multiple networks integrated”, and the communication interface or application interface is configured in the middle area of the display, corresponding to the menu items. The communication application interface and the first application interface are generally located in the middle of the display with a large area covered, thereby providing a main area for the user to recognize and operate. displaying content may be switched one at a time by sliding the communication interface, synchronously changing a focus option, namely the current option, of the at least one option in the menu area, which corresponds to the interface currently displayed in the middle of the display. The menu area is located at the bottom or lower part of the screen, the one page of options, such as 5 menu items, in the menu may be switched to left or right by sliding the menu area on the screen. In response to the user click operation, the option clicked by the user may be determined as a new focus option in the menu area or the single row area 2602, and the corresponding communication interface or the application interface will be loaded in the middle of the display. This abbreviated menu item may present more contacts, applications and other options in a smaller scale to the user with a navigation function, and multiple contact/application options, in a group as a unit, may be collectively switched, in response to a single sliding operation by user, thereby facilitating the user to quickly browse or select the contacts, with whom he/she want to communicate with, and so on.

In the method according to some embodiments of the present invention, including those relevant embodiments under the headlines of “Single card mode”, “Communication by multiple networks integrated”, the at least one option 2603 further comprises a second option 26b. In the relevant method, the communication interface for the first contact 26-Contact corresponding to the first option 26a is switched to the interface 26-Album corresponding to the second option on the display in response to the user selection of the second option 26b in the single row area 2602, and synchronously, the focus will be shifted from the first option 26a to the second option 26b, this is, the second option is formally differentiated in a single row area.

Of course, the switching style of the above focus option and current interface is also applicable to cross-group option selection. For example, the user switches the first group of options to the second group of options headed by 26e by sliding operation in the single row area 2602, while it is still the communication interface for the first contact 26-Contact corresponding to the option 26a in the first group of options that is possibly displayed in the interface 2601. Herein, the electronic device may switch the communication interface for the first contact to the contact group interface 26-Group corresponding to option 26e in response to the user click operation on the fifth option 26e. And, synchronously, the option 26e is formally differentiated in a single row area as the focus option, namely the current option which is an option for the interface currently displayed on the display.

FIG. 12A and FIG. 12B are schematic diagrams of switching between two interfaces configured in an electronic device according to an embodiment of the present invention. As shown in FIG. 12A, according to relationship between the current contact and the user, the current contact is nicknamed as “son”. There are five options in thumbnail provided in a single row in the menu area laterally configured at the bottom of the display, wherein the first option 2703-1 corresponding to the “son” is highlighted, for example, the outline of the thumbnail of the option is displayed in a highlighted state. on the communication interface 2701 for the current contact is loaded with a profile for the “son”. Also a virtual communication key 2702 associated with one or more communication networks is provided on the communication interface 2701 for the current contact, for the user to operate so as to establish communication to generate message(s) via the above one or more communication networks. Communication interface 2701 for the current contact is also provided with message area 2704 for outputting messages between the user and his/her “son”.

In the method according to some embodiments of the present invention, including those relevant embodiments under the headlines of “Single card mode”, “Communication by multiple networks integrated”, a plurality of objects have a plurality of interfaces, corresponding to the plurality of objects one by one, for example, the first contact object and the corresponding communication interface for the first contact, album application object and the corresponding album application interface, and the like. These interfaces, may be output in the middle of the display with a larger area covered, thereby forming a main area for the user to recognize and operate. The plurality of objects are relatively independent, and may become interactive on the display by means of multiple corresponding interfaces. Deep functions of the corresponding objects may be invoked and sub-interface for further operation or jumping will be presented on the display according to the user operation on the interface. The plurality of interfaces corresponding to the plurality of objects may also be substantially independent of each other and may be output on the display in a switchable manner for user access. In the abovementioned method of some embodiments, the switching between these interfaces, are performed by the user operating the menu area for navigation. In some methods of the following embodiments, the user will be allowed to directly apply switching operation to the communication interface, the application interface and the like, so as to perform switching between the multiple interfaces.

In the method according to some embodiments of the present invention, including those relevant embodiments under the headlines of “Single card mode”, “Communication by multiple networks integrated”, the electronic device may be programmed to switch the communication interface for the current contact to an interface corresponding to an object adjacent to the current contact in the at least one object, in response to a single switching operation on the communication interface for the current contact by user, for example, a leftward or right swipe slide gesture operation. Optionally, the outputting order that the at least one object is output by the display in the form of interface(s) in response to the predetermined gesture of the user has been predefined. If there is a menu area further provided on the display, the electronic device may also formally differentiate the options to which the updated current contact, after the switching operation, corresponds in the menu area, substantially in sync with switching of the current contact communication interface in the electronic device. Preferably, the current options in the menu area may be formally differentiated so as to facilitate the user more conveniently identify from the menu area.

In the method according to some embodiments of the present invention, including those relevant embodiments under the headlines of “Single card mode”, “Communication by multiple networks integrated”, the electronic device may be configured to switch the communication interface for the second contact corresponding to the second option 2703-2 adjacent to the first option 2703-1 in the single row area 2703 on the display, as shown in FIG. 12B, in response to a single switching operation by user on the communication interface for the first contact 2701, for example, a leftward sliding operation as indicated by the arrow in FIG. 11. According to the relationship between the second contact and the user, the second contact is nicknamed as “daughter”, and the communication interface for the “daughter” is loaded with a profile for the daughter, which may include the nickname, avatar, photos, phone number for the “daughter”, etc. Correspondingly, message area 2704 may also be employed to display message(s) with the “daughter”. Corresponding to the switching of the communication interface for the current contact, the formally differentiating means such as focus or the like is transferred from the first option 2703-1 to the second option 2703-2 corresponding to “daughter” among the five options in the single row area 2703.

Optionally, if the second option 2703-2 corresponding to the “daughter” is the last valid option in the single row area 2703, there will be a configuration option provided in the single row area 2703, for example, which may follow the second option 2703-2 (not marked in the figure). The electronic device may be programmed to add an icon of a new application or the like to the blank position (not marked in the figure) in the single row area 2703 in response to the user operation on the configuration option, wherein the newly added application may be a communication application interface for a third contact or an album application, and the like. The user interface of the newly added application may be output, in activated state, by the display for the user to access, when the user selects the newly added option in the abovementioned single row area 2703. Of course, all of these options and associated applications therewith may be managed or scheduled by an application manager, and the application manager may be launched by the user from the desktop (not shown in the figure) of the electronic device, thereby providing the user with a user interface via the application manager. The UI of the application manager may include interface elements such as the single row area 2703 for accommodating abbreviated options. The user may launch the associated applications or application interfaces by operating these options. The application manager may be configured in the electronic device as a separate application independent of the operating system.

Herein, it should be noted that, in some embodiments, the user of the electronic device configured with multiple applications or a plurality of contact information may be an elderly person. Therefore, optionally, the install portal of these applications is deployed to a remote second terminal, and a professional user of the other electronic device (for example, a young person who is a child of the elderly person) operates the second electronic device to remotely perform installation, uninstall or other maintenance for the multiple applications in the electronic device of the embodiment of the present invention by the communication link between the electronic device and the second electronic device (optionally via a server). Of course, after the application is installed/uninstalled in the electronic device, or the contact information is added, the professional user may perform corresponding settings such as addition, deletion on the menu items presented on the display of electronic device used by the elderly, by operating the corresponding interface and entrance on the second electronic device. In this case, configuration options for adding menu items are not necessarily provided in the option area of the embodiment(s). Of course, aside from remotely configuring the menu items, other information in the electronic device may be also remotely edited and customized This further shields the user of the electronic device from the presence of an OS of the electronic device, reducing the cognitive difficulty of the electronic device.

It should be appreciated that whether a single row area 2703 and multiple options therein are configured as a navigation menu in FIG. 12 or not, a plurality of objects (not shown in the figure) in the electronic device may be independently configured in a predetermined order and output by the display. In this manner, the electronic device may output a plurality of interfaces corresponding to the plurality of objects one by one for user interaction, in response to a single switching operation for the interface by user, such as a leftward/rightward sliding operation. In other words, the electronic device may be responsive to a single switching operation(such as left/right sliding operation) of communication interface for the “son” by user, the next to-be-loaded object is switched to the object adjacent to the communication object with the nickname of “son” in the plurality of objects arranged in predetermined order, which is “daughter” communication object, and the communication interface corresponding to the object of “daughter” is presented on the display, as shown in FIG. 12B. To sum up, either the plurality of application interfaces or multiple objects associated therewith provided in the electronic device may be configured in a predetermined order. The electronic device will output the plurality of interfaces one by one by the display in the predetermined order if the user applies continuous switching operations to the communication interface or the application interface, for example, repeating the above-described leftward sliding gesture on the display. If a menu area or a single row area and a plurality of options therein are not presented on the display, the predetermined order described above may be an outputting order with which a plurality of interfaces are pre-assigned in the electronic device; if a single row area and a plurality of options therein is presented on the display as a navigation menu, the predetermined order described above may be the order that the plurality of options are arranged in the queue of the single row. For example, as shown in FIG. 11, the current interface is the interface 26-Contact corresponding to the option 26a, and when the user repeats switching operations on the middle of the display 2601 where is the Interactive area of the current UI, such as a leftward sliding gesture for switching, the electronic device 2600 will sequentially present, by the display 2601, the 26-Album corresponding to the option 26b, the interface(not shown in the figure) corresponding to the option 26c, the interface(not shown in the figure) corresponding to the option 26d, and the interface 26-Group corresponding to the option 26e. Preferably, after each interface switching occurs to the display, the option in the single row area corresponding to the currently loaded communication interface or the application interface will be formally differentiated so as to facilitate the user to recognize the current option. Optionally, in the method according to some embodiments of the present invention, including those relevant embodiments under the headlines of “Single card mode”, “Integrated communication by multiple networks”, multiple objects corresponding to multiple options may include but not limited to: messages/parameters for one or more contacts and related communication applications, photo album applications, daily information applications, and the like, and multiple interfaces are interactive interfaces of the corresponding applications.

As abovementioned, the plurality of options within the single row area 2703 is similar to shortcuts, and the component of the plurality of options may also be edited, or the arrangement order of the plurality of options may also be configured, by the foreground interface or via backdoor login. In other words, the method of the above or below embodiments may further comprise the step of: adding the first contact into the electronic device and presenting the option for the first contact in the single row area 2703 for navigation in response to an contact adding operation by user.

This customization for the content of the menu area or single row area 2703 makes the content therein extensible, thereby enhancing the navigation effect of the area. Optionally, a contact option may include parameter(s) for the first contact, such as a unique identification of the first contact for the electronic device or a software system running therein, or may further include, for example, a phone number, an unique identifier (ID) employed in instant messaging. Meanwhile, the first contact option in the menu area is associated with a communication program(s) locally or remotely provided in the electronic device, and the first contact option may be located at the top layer of the interaction hierarchy of the entire software system in the electronic device for direct operation by user, similar to a shortcut, and thus, in response to the user operation of the first contact option in the menu area, the corresponding communication application configured in the electronic device will be is called by the shortcut, meanwhile, some parameters for identifying the contact will be passed to the associated communication application program(s), the communication application program(s) will be started and the relevant communication functions will be run for the first contact to which the passed parameters corresponds, thereby presenting relevant information of the first contact, including the profile, message(s) between the user and the first contact and the like by the communication interface on the display. The abovementioned parameters for identifying the contact includes but not limited to the items mentioned under the headline of “Integratedly storing multiple communication network messages for contact(s) in a single program”. Of course, in addition to information/parameters such as the contact number applicable to the mobile phone network and the identification (ID) applicable to the instant messaging software mentioned under the headline abovementioned, other parameters or information representative of the contact may be set, and one of the purposes of these parameters/information is to allow the communication application to load the communication interface of the corresponding contact according to these parameters/information, thereby enabling the user to establish communication with the contact by the communication interface, and the specific form of the parameter/information does not constitute a limitation of the present invention.

Optionally, in the method or electronic device according to some embodiments of the present invention, including those relevant embodiments under the headlines of “Single card mode”, “Integrated communication by multiple networks”, the at least one interface 2604 or the at least one option 2602 belongs to a single program, or although the at least one interface 2604 is partially deployed in a remote server, it is ultimately provided to a single program in the electronic devices by program call. A conventional operating system such as Android may be customized to integrate a portion of the program related to the communication interface into an operating system of the electronic device to form a system-level single program, with the program component to which the communication application interface belongs as an operating system user interface (UI), and the plurality of interfaces in the single program will be presented to the user at the first moment after the startup is completed. The single program may be run during the electronic device startup, such that the at least one interface 2604 including the communication interface for the first contact, the photo album application interface and the like will be automatically loaded, in a switchable manner, at the top of the interaction hierarchy of the entire software system in the electronic device for the user to directly operate after the electronic device is started, which improves the accessibility of the communication resource and reduces the interaction complexity during the interaction process of acquiring relevant communication resources and application resources. As shown in FIG. 11, after the electronic device is started, the plurality of interfaces 2604 are automatically loaded on the top interaction layer of the electronic device for the user's direct operation after the electronic device is started, thus allowing the user to switch the interface 26-Contact, interface 26-Album, . . . , interface 26-Group in parallel manner by a switching operations such as horizontal sliding gesture, etc., and to access to these different applications.

Optionally, one or more options of the head in the queue of the at least one option may be set as option(s) for contact, correspondingly, the first interface 26-Contact in the at least one interface 2604 not only appears at the top interaction level of the electronic device, but also is loaded as the first interface, as a contact communication interface, in the electronic device after the electronic device is turned on and working normally. This further improves the accessibility of the communication resource and reduces the interaction complexity during the interaction process of obtaining relevant communication resources or application resources.

In the method or the electronic device according to some embodiments of the present invention, including those relevant embodiments under the headlines of “Single card mode”, “Integrated communication by multiple networks”, a communication between the user and a contact group is also supported. FIG. 13A and FIG. 13B are schematic diagrams of two mutually switchable interfaces configured in an electronic device according to an embodiment of the present invention. The plurality of options accommodated in the single row area 2803 of this embodiment comprise an option 2803-4 for the first contact group and an option 2803-2 for the second contact. Correspondingly, the electronic device 2600 may also switch to present a communication interface for the second contact (not shown in the figure) or a communication interface for the first contact group on the display respectively in response to the user selection of the option 2803-2 for the second contact or the option 2803-4 for the first contact group, as shown in FIG. 13B or FIG. 13C. The communication interface for the second contact and the communication interface for the first contact group formally and functionally correspond to the communication interface for the first contact, for example, both having profile 2805a, 2805b, the message area 2806 is also provided on the interface for the second contact or the contact group, for output of the message(s) with the second contact or members of the contact group. It should be noted that the configuration method of a communication interface for a single contact or the application interface, the interface resource providing method/step(s), proposed in the method or the electronic device according to some embodiments of the present invention, including those relevant embodiments under the headlines of “Single card mode”, “Integrated communication by multiple networks”, may be applicable to the contact group herein, and a special case of the contact group is only two members involved, namely, the user himself/herself of the electronic device and the contact.

In FIG. 13C, the message area 2806a outputs a plurality of messages between the user and the member of the contact group. In order to make the associating relationship between the output interface elements more explicit, associating relationship between the message(s) from the first member in the message area 2806 and the first member's profile of the contact group, such as the avatar, may be prominently revealed on the communication interface. For example, as shown in FIG. 13C, the second member's avatar of contact group is highlighted in blue, correspondingly, in the message area 2806, the communication record of the second member, for example, the second, third, and the latest piece of communication record at the bottom are also highlighted in blue. Since both the communication record and avatar, corresponding to each other, are highlighted in the same/similar color, thereby strengthening the expression, to the user, of the association between the two and facilitating the user to recognize the group member(s) and the messages corresponding thereto. Optionally, as shown in FIG. 13B as well, the message area 2804 in the figure operates to output only the latest communication record for the group, which referrers to the resource providing method and interface configuring method of the embodiment under the headline of “Single card mode” for detail. Assuming that the latest communication record is from the group member corresponding to the upper left avatar in the profile 2805b, the avatar 280c of the member in the contact group is displayed in the proximity of the message area 2804 to prompt the user about the sender of the latest communication record. Alternatively, in FIG. 13B, as a variation of the explicit association between the profile of the first member and the message(s) of the first member, in response to the occurrence of the latest one of communication records with the first user, the profile of the first member in the contact group, such as the avatar 280c, may be revealed, in an area where the profile 2805b is located, in a dynamic manner such as in an enlarging manner or flashing manner (not shown in the figure) with respect to the avatars of other members in the contact group. Relative to the first member, the avatars of other members in the contact group are revealed in an abbreviated or static manner in a circular area or a strip area in which the profile 2805b is located, whereby the user may be prompted: the sender or receiver of the communication record revealed in message area 2804 is the first member. Optionally, it is only the latest one of the message(s) between the contact groups that may be revealed in the message area 2804, and the latest one of the communication records comes from the first member of the contact group.

As another variation wherein the contact and its corresponding communication record are displayed dynamically in proximity to each other, the latest message in the message area 2806 is assumed to be always at the top of the message area 2806, which is the piece of communication record 2806-1 nearest to the profile 2805a. Correspondingly, in the electronic device, the order of avatars in the profile 2805a may be dynamically arranged, and the sender of the latest communication record 2806-1 is always arranged in the first position 2805a-1 of the avatar queue in the profile 2805a, namely located at the leftmost position of the avatar queue on the screen, such that the distance between this position and the latest communication record 2806-1 is relatively small, thereby facilitating the user to visually associate the latest communication record 2806-1 with its corresponding sender's avatar or identity. Of course, it should be appreciated that, alternatively, the latest message may also always stay at the bottom of the message area 2806, and the avatar queue of the profile may also be set at the bottom of the communication interface, while the sender's avatar of the latest communication record is dynamically arranged to always occupy the first position of the avatar queue so as to keep close to the presentation position of the latest communication record in the message area.

Optionally, in the method or the electronic device according to some embodiments of the present invention, including those relevant embodiments under the headlines of “Single card mode”, “Integrated communication by multiple networks”, the menu area 2803 in single row further comprises an option for individual first application or an option for the application set (not shown in the figure); the electronic device may correspondingly switch to the first application interface on the display in response to the user selection of the option for the first application, the application interface of daily information such as time/weather or the photo/album application interface, as shown in FIG. 13D and FIG. 13E. The electronic device may correspondingly switch to the interface for the application set on the display so as to collectively present the entries for a plurality of different applications in response to the user selection of the options for the application set.

Specifically, the electronic device may virtually output the calendar information and the weather information by the middle area 2904 of the interface for the first application respectively in response to the operation of the first virtual key in lower part of the virtual key group 2902, the second virtual key in the middle of the virtual key group 2902 on the right side of the first application interface by the first application interface on the display in FIG. 13D. Besides, the electronic device may also audibly or visually output the time information by the middle area 2904 of first application interface, in response to the user operation on the third virtual key in the upper part of the virtual key group 2902 on the first application interface.

Specifically, the electronic device may enable the camera for the user to take photo or video in response to the user operation on the third virtual key in the upper part of the virtual key group 2902 by the second application interface for the photo/album on the display in FIG. 13E. Besides, the electronic device may also play relevant photo or video and stop playing these photos and videos by the middle area 2904 in first application interface respectively in response to the operation of the first virtual key in the lower part, the second virtual key in the middle portion, of the virtual key group 2902 on the first application interface. Optionally, in the method or the electronic device according to some embodiments of the present invention, including those relevant embodiments under the headlines of “Single card mode”, “Integrated communication by multiple networks”, the distance between the third virtual key and the first virtual key is bigger than that between the first virtual key and the second virtual key. The first virtual key and the second virtual key are adjacently set. The key arrangement/layout herein is correspondent to the virtual or physical key group included in the operation interface for communication on the communication interface in some other embodiments, thus contributing to the consistency of the user experience when user interacts with different interfaces of the method and the electronic device in relevant embodiments.

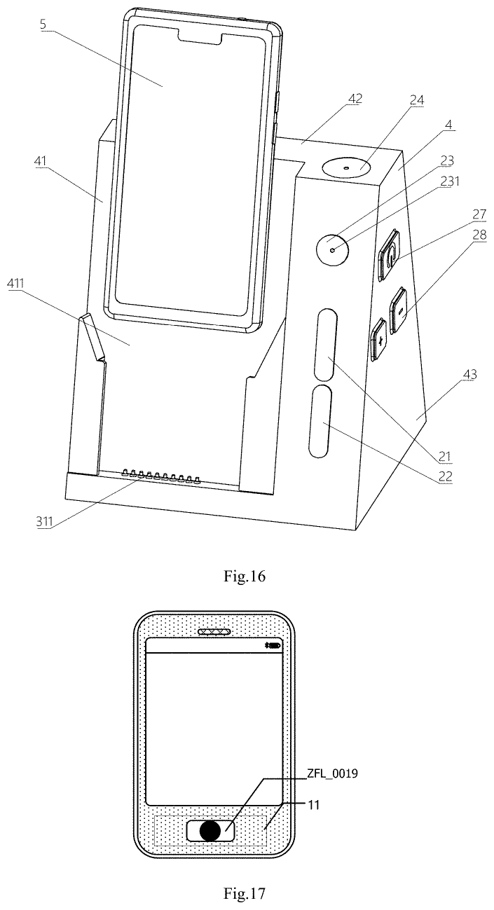

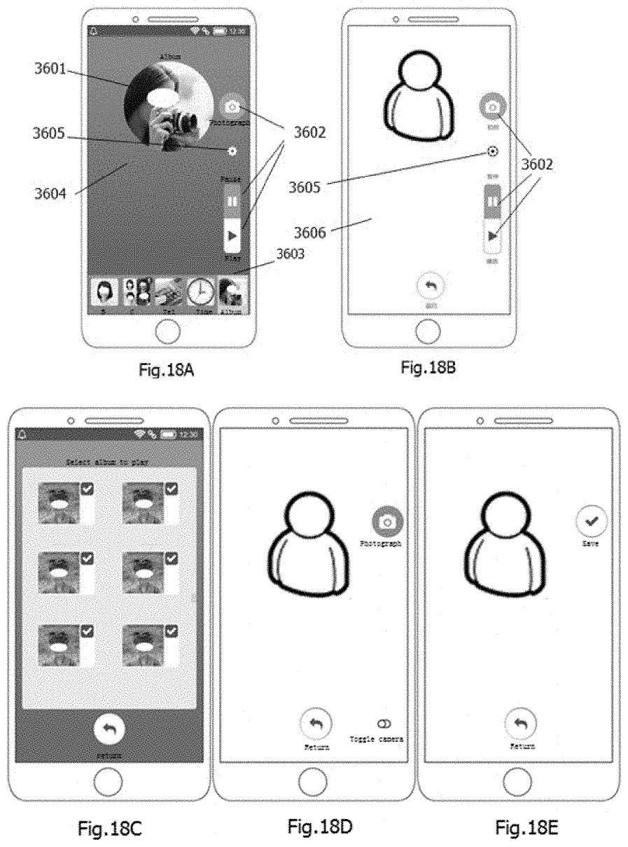

FIG. 18A˜FIG. 18E are schematic diagrams of an album application interface according to an embodiment of the present invention; the resource providing method of the relevant embodiments will be described below with reference to the diagram groups.

The interface shown in FIG. 18A may work as a main interface for album feature, the interface has a sliding bar 3603 including a plurality of contacts and a plurality of operable options such as a virtual key group 3602 for the album-related operation by the user' trigger. In the interface shown in FIG. 18A, a play option, such as the key at the bottom of the virtual key group 3602, may be triggered, then the album photo play interface shown in FIG. 18B will be switched as current interface, and a plurality of operation options such as the virtual key group 3602, are still retained in the interface for the user to operate for the album-related feature, and there is another back option for the user to operate to return to the home interface for album feature. An album selection option may be triggered in the interface shown in FIG. 18B or FIG. 18A to enter the interface for selecting an album to be played as shown in FIG. 18C, there providing a plurality of albums for the user to select to play and a back option for the user to operate to return to the homepage interface for album feature or the album play interface. A take photograph option on the interface shown in FIG. 18B or FIG. 18A, is operable to enter the take photograph interface shown in FIG. 18D, wherein a confirming capture option and switching camera option is provided in the interface, and additionally a back option for the user to operate for returning to homepage interface of album feature or album photo play interface; the interface displayed in FIG. 18E shows is a photo save interface after triggering the confirming capture option in the interface shown in FIG. 18D, there providing a save option in the interface, for the user to operate to save the taken photo, and additionally a back option for the user to operate for backing to take photograph interface so as to capture again. Therein, the blank box in the above view represents avatar(s) for a single contact or contact group, or logo picture in a function bar, photo, album thumbnail, and a preview for capturing photo, and the like.

In the method or the electronic device according to some embodiments of the present invention, including those relevant embodiments under the headlines of “Single card mode”, “Integrated communication by multiple networks”, in the first application interface may be provided with an album application function. Correspondingly, the three keys in the virtual key group 3602 may be functionally redefined in the capturing application for the function attribute(s) of capturing interface.

Optionally, in the method according to some embodiments of the present invention, including those relevant embodiments under the headlines of “Single card mode”, “Integrated communication by multiple networks”, the electronic device may enable the camera of the electronic device for the user to take a photo or video in response to the user operation on/off the third virtual key located at the top of the virtual key group 3602 on the first application interface 3604. The electronic device may play the photo/video by the first application interface 3604 in response to the user operation of the first virtual key located in the lower portion of the virtual key group 3602 on the first application interface 3604, and stop playing the photo/video by the first application interface 3604 in response to the user operation of the second virtual key located in the middle of the button group 3602 on the first application interface 3604. Preferably, the photo/video is played, in an automatic slide show, by the photo album application provided in the first application interface 3604, and may restart, at any time, the picture capturing resources of the electronic device for the user to take photo or video in response to the user operation of/on the third virtual key at the top of the virtual key group 3602 on the first application interface 3604.

Specifically, the function configuration and interaction manner of the abovementioned virtual key group 3602 implemented in the three-key mode may be further described as follow:

Capturing: in the slideshow, the camera may be called out for entering into the photo capturing state, as shown in FIG. 18D, in response to the user operation of the third virtual key located at the uppermost portion of the virtual key group 3602. When the camera is called out, the third virtual key at the top of the virtual key group 3602 may be functionally redefined as a photo shutter button. The electronic device may restore on the display the slideshow of the photo/video shown in FIG. 18B, in response to the user operation of the “back” key at the bottom of the first application interface as shown in FIG. 18D. After the above third virtual key, redefined as the shutter, is pressed to take photograph, the third virtual key may be further functionally redefined as “save picture”. Herein, the electronic device may save the captured picture or abandon the captured picture to return to the photo capturing interface shown in FIG. 18D respectively in response to the user operation of the third virtual key labeled by “save” shown in FIG. 18E or the key labeled by “back” in the lower portion of the first application interface.

Pause: pausing the slideshow of photo/video play. The play of photo or video is paused on the first application interface 3604 in response to the user operation of the second virtual key located in the middle of the virtual key group 3602 on the first application interface 3604.

Play: Automatically starting the slideshow and playing the designated photos in the picture folder in a loop manner. The electronic device may play the photo/video by the first application interface 3604 in response to the user operation of the first virtual key located in the lower portion of the virtual key group 3602 on the first application interface 3604.

In addition to the three keys in the virtual key group 3602, there is a button 3605 provided on the first application interface 3604, located between the middle key and the upper key of the virtual key group 3602, substantially in the same column with the three keys of the virtual key group 3602. A folder option may be provided on the first application interface 3604 as shown in FIG. 18C, in response to an operation such as a clicking on the button 3605. This folder option is for the user to select the relevant photo or photo folder for playback interface of the photo/video in FIG. 18B, with multiple selection of photo or photo folder supported, and the photo folder may be created and managed according to parameters such as capturing date.

Key/Button Arrangement and Its Modality, Function

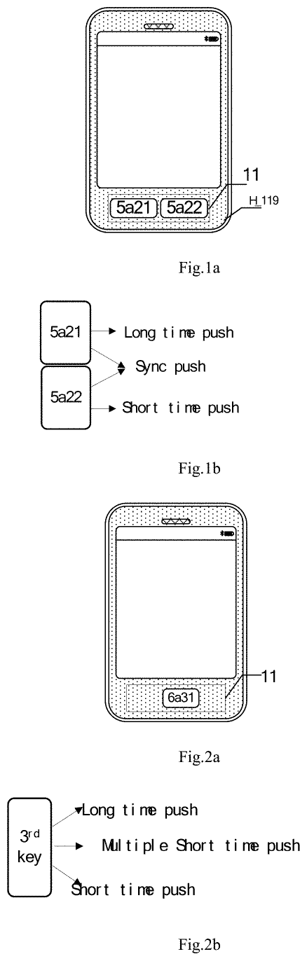

FIG. 1a is a schematic structural diagram of a physical keyboard provided in an embodiment of the present invention. As shown in FIG. 1a, the physical keyboard includes a first key 5a21 and a second key 5a22. Optionally, the first key 5a21 and the second key 5a22 is detachable with respect to the body of the communication device, such as a cell phone, and may be disposed on a base physically independent (not shown in the figure), connected to a processor in the terminal communication device via the physical interface (not shown in the figure) of the connector between the body of the communication device and the base.

Optionally, the first key 5a21 and the second key 5a22 may be disposed, for example, adjacently, on the first side (front panel) or the second side of the housing H_119. The two physical keys may be in a square or circular shape of appearance structure. Of course, the first key 5a21 and the second key 5a22 may also be disposed in a distributed/dispersed/spaced manner, for example, one disposed on the first side of the housing and the other disposed on the second side of the housing; alternatively, the first key 5a21 and second key 5a22 first may be disposed on the same surface of the housing in a distributed/dispersed/spaced manner. In other optional variants, the first key 5a21 and the second key 5a22 may also be connected together, or integrated. And the configuring manner for the keys mentioned herein may also be applicable to the above or below embodiments of the present invention, which will not be repeated in other portion of the present application.

Optionally, the first key 5a21 may cause a first trigger signal for the processor 12 in response to a first single action by a user. then, the processor 12 may collect the first media signal shorter than the preset duration by means of the media collection unit 13 in response to the first trigger signal and send the first media signal via the wireless data transmission network by the wireless data transmission unit 15, wherein the second key 5a22 may send a second trigger signal to the processor 12 in response to a second single action by the user. In response to the second trigger signal, the processor 12 may output, by the media play unit 14, the second media signal received by the wireless data transmission unit 15 via the wireless data transmission network.

Optionally, the first media signal and the second media signal may respectively include voice message and/or video/image message, the duration of which is shorter than a preset value.

As illustrated in FIG. 1a, the first key 5a21 and the second key 5a22 may be keys for pushing, which may be coupled to the processor directly or by a physical interface (not shown in the figure), and detachable with respect to the cell phone by the physical interface. Therefore, in this embodiment, the first single action may be a long time press operation (one time of press with a longer duration, for example, at least 2 seconds), and the second single action may be a simple operation such as single press operation less than 1 second, or multiple press operations, fast and consecutive.

In this embodiment, the two physical keys abovementioned are set for the user to realize different communication requirements with respective operation on the two physical keys, such as sending the first media signal and playing the received second media signal.

It should be described that, in this embodiment, by the collection and transmission of the first media signal, the user may be allowed to meet the communication requirements of the voice message or the audio and video message for the contact by a one-key operation, wherein, the processor 12 may collect, in response to the first trigger signal, the first media signal that does not exceed the preset duration by the media collecting unit 13.

Specifically, the processor 12 may control the maximum collection duration (that is, the preset duration) of one time collecting operation of the media collection unit 13, for example, 1 minute, such that the user may only send a media data of at most 1 minute to the contact at a time. When the user still needs to continue to send, he/she may re-trigger the first key 5a21 with the first operation. In practical application, taking it as an example that the first single action is a long press operation, the user may perform a long press operation on/for the first key 5a21 to cause the collection of the first media data (taking voice as an example), and the user starts to speak after pressing the key 5a21, meanwhile, the media collection unit 13 starts to collect the voice of the user under the control of the processor 12. If the user releases the key if the duration of the pressing does not exceed the longest collection time, then the media collection unit 13 will stop collecting under the control of the processor 12 and send the collected voice to the processor 12. Instead, if the user has not released the key but the duration of pressing has reached the longest collecting duration, then the media collection unit 13 may stop collecting under the control of the processor 12 and send the collected voice to the processor 12.

In this embodiment, after the user performs the first single action on the first key 5a21, the media collection unit 13 will be caused to record the first media signal for a certain period of time, and then the first media signal will be sent out by the processor 12, thereby allowing the user to send voice message to the contact in this way.

In a practical application, the processor 12 may first compress and encode the first media signal by using a certain coding standard, such as H.264 in the process of sending the first media signal, and then the processor 12 may encapsulate the compressed and encoded first media signal according to a certain network transmission protocol such as TCP, UDP, etc and send the encapsulated data packet to the electronic device online for the peer contact.

In this embodiment, in addition to being independently operable to trigger the collection and transmission of the first media signal and the play of the second media signal respectively, optionally, the first key 5a21 and the second key 5a22 may send a third to the processor 12 in response to a third operation, and the processor 12 will initiate an audio or video call via the wireless data transmission network by the wireless data transmission unit 15 in response to the third trigger signal. Optionally, the third operation may be a pressing operation synchronously applied to the first key 5a21 and the second key 5a22.

Specifically, the user may apply the third operation to the first key 5a21 and the second key 5a22 that is, synchronously pressing the first key 5a21 and the second key 5a22, after selecting a certain contact in the communication application. Thus, the first key 5a21 and the second key 5a22 will respectively send the third trigger signal to the processor 12, and the processor 12 will further initiate an online audio or video call to the corresponding contact after receiving, at the same time or in a short time interval, the third trigger signal respectively sent from the first key 5a21 and the second key 5a22.

It should be appreciated that if the contact answers the audio or video call, the processor 12 will control the media collection unit 13 to start collecting the media signal (referred to as the third media signal) of the user and send the third media signal, collected in real time, to the contact side. The third media signal may be an audio or video signal collected by a microphone and a camera.

To more clearly illustrate that different operations on the first key 5a21 and the second key 5a22 correspond to different communication processes, as shown in FIG. 1b, a relationship between the different operation on the first key 5a21 and second key 5a22 and the corresponding communication processes is illustrated: performing a long press operation on the first key 5a21 so as to trigger the recording of the first media signal with a limited duration and sending the first media signal when the first key 5a21 being released; performing a short press, namely a single time press operation, on the second key 5a22 to trigger the playback of the received second media signal; an audio or video call may be initiated by simultaneous press on the first key 5a21 and the second key 5a22.

Optionally, the physical keyboard may further include another key disposed adjacently to the first key 5a21 and the second key 5a22. The initiating audio and video call may be implemented by performing a short press operation on this key.

To sum up, by the two physical keys (the first key and the second key) disposed in this embodiment, the user is allowed to address the communication requirements such as voice messaging, receiving message and playing and online audio and video call by simple operation on the two physical keys.

FIG. 2a is a schematic structural diagram of another physical keyboard according to an embodiment of the present invention. As shown in FIG. 2a, the physical keyboard comprises a third key 6a31. In this embodiment, the third key 6a31 may trigger, directly or by a physical interface, the first trigger signal and the second trigger signal to the processor 12 respectively in response to the first single action and the second single action.

In response to the first trigger signal, the processor 12 may collect the first media signal shorter than a preset duration by the media collection unit 13 and send the first media signal via the wireless data transmission network through the wireless data transmission unit 15. And in response to the second trigger signal, the processor 12 may output, by the media playback unit 14, the second media signal received by the wireless data transmission unit 15 via the wireless data transmission network.

Optionally, the third button 6a31 may also send the third trigger signal to the processor 12 in response to the third single action. In response to the third trigger signal, the processor 12 may initiate an audio or video call via the wireless data transmission network by the wireless data transmission unit 15.

In this embodiment, the user may address the communication requirements of transmitting a media signal clip, playing the received media signal, and initiating an online audio and video call by a single action operation on a physical key.

Optionally, as shown in FIG. 2a, the third key 6a31 may be a key for push/press, such that the operations that may be performed on the key include, for example, a single pressing operation, a relatively continuous multiple pressing operations, and a long time pressing operation. Thus, optionally, the abovementioned first operation, the second operation, third operation may respectively be a long time pressing operation, a single pressing operation, and multiple pressing operations. And the logic of responding to process in the processor 12 when the user respectively applies different operations may be referred to related embodiments, which is not repeated herein.

In order to more clearly illustrate that the different operations of the third key 6a31 correspond to different communication processes when the third key 6a31 is implemented as a key for push/press, as shown in FIG. 2b, a relationship between the operation of the third key 6a31 and different corresponding communication processes is illustrated: performing a long pressing operation on the third key 6a31, triggering the recording of the first media signal with a limited duration and sending the voice message when the third key 6a31 being released; performing a short pressing operation, namely a single pressing operation, on the third key 6a31 so as to trigger the playback of the received second media signal; and initiating an audio and video call by performing multiple short pressing operations on the third key 6a31.

To sum up, the user only needs to respectively perform simple operations on at least one physical key included in the physical keyboard 11 to address different communication requirements by the physical keyboard 11 provided in the communication device of the present invention, and not only convenience for operation, but the timeliness and reliability that the user send the communication message to the contact and the real time performance for receiving the communication message from the contact are also guaranteed.

Optionally, as shown in FIG. 17, the third key 6a31 may also be a toggle key ZFL_0019 of self-resetting type, which at least includes: a stalk, an elastic member supporting the stalk under the stalk, thus, the first operation may be a toggle in the first direction, the second operation may be a toggle in the second direction, and the third operation may be a press in the third direction.

Optionally, the toggle in the first direction, the toggle in the second direction, and the press in the third direction of the elastic member respectively trigger different electrical states on the input port of the processor 12 so as to cause the processor 12 to recognize what user's operation is at present.

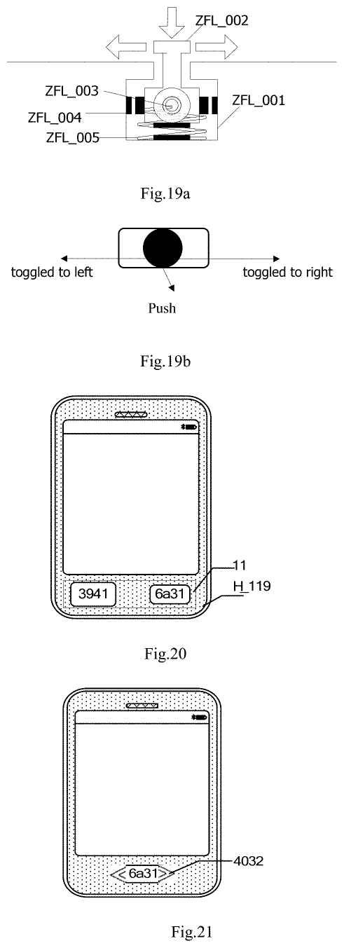

A specific structure of a toggle key ZFL_0019 is illustrated in FIG. 19a, the toggle key includes: a stalk, an elastic member supporting the stalk under the stalk, and one pair of metal contacts on the first side of the stalk, the other pair of metal contacts on the second side of the stalk, another pair of metal contacts on the third side of the stalk. The toggle in the first direction causes the pair of metal contacts on the first side to be in conduction, the toggle in the second direction causes the pair of metal contacts on the second side to be in conduction, and the pressing in the third direction causes the pair of metal contacts on the third side to be in conduction.

The material of the elastic member is metal. Optionally, the toggle key may also include a rotatable shaft ZFL_003 for supporting the elastic member ZFL_005, and the stalk is secured to the rotatable shaft ZFL_003. Optionally, each pair of metal contacts may be a metal piece with a certain volume.

Optionally, the toggle key ZFL_0019 is housed in a cavity ZFL_001 that limits the amplitude to which the key may be toggled. Optionally, each side of above three sides may be equipped with one pair of metal contacts, one contact of the metal contact pair ZFL_004 is disposed on the corresponding side of inner wall for the cavity, and the other metal contact may be symmetrically disposed on the elastic member ZFL_005. The metal contacts disposed on the inner wall of the cavity may be connected to the processor 12 such that the toggle in the first direction may cause the pair of metal contacts on the first side to be in contact for conducting, thereby sending the first trigger signal to the processor 12; The toggle in the second direction may cause the pair of metal contacts on the second side to be in contact for conducting, thereby sending the second trigger signal to the processor 12; the pressing in the third direction may cause the pair of metal contacts on the third side to conduct by contacting to send the third trigger signal to processor 12. Thus, the connection with the processor 12 is turned on when the metal contacts on corresponding side are conducted, such that the processor 12 will perform the processing of the subsequent communication in correspondence with the direction of the toggle or press operation currently triggered by the user.

Optionally, the third key, such as the metal contact facing towards in the above three directions, may be connected to the processor 12 in a direct manner, such that when a user applies different operations, a port directly connected to the processor 12, such as a GPIO interface, varies in electrical level state. Of course, the third key may also be connected to a different port of the GPIO of the processor 12 by other circuit structures such as logic processing circuits, thereby generating different level state on the corresponding GPIO interface of the processor by the logic processing circuit according to the user-triggered operation.

Since the toggle key may be toggled or pressed in different directions to address different communication requirements, therefore, generally, the toggle key is a self-resetting key. That is to say, when the user performs the toggle in the first direction, the stalk may be automatically reset after the stalk is released, thereby allowing the user to perform the next operation in some direction.

When the third key 6a31 is implemented as the toggle key illustrated in FIG. 17 and FIG. 19a, in order to more clearly describe that the different operations of the toggle key correspond to different communication processes, as shown in FIG. 19b, the figure illustrates a relationship between different operations of the toggle key and corresponding communication processes: triggering the recording of the first media signal shorter than a certain duration when the toggle key is toggled to the left, and the voice messages will be sent after the key being released; triggering the play of the received second media signal when the toggle key is toggled to the right; initiating an audio or video call when the toggle key is pressed down at the reset position.

FIG. 20 is a schematic structural diagram of still another physical keyboard according to an embodiment of the present invention. As shown in FIG. 20, the physical keyboard includes a fourth key 3941 configured to send a fourth trigger signal to the processor 12 in response to the fourth operation. The processor 12 may initiate a group audio call or a group video call to member(s) of the emergency contact group via the Internet or alternatively via the public switched telephone network by the wireless data transmission unit in response to the fourth trigger signal. Optionally, alternatively means backup, namely, if a network fails, the call may be made via another network.

In the embodiment of the present invention, the user may carry out the emergency call in an emergent situation apart from the transmission of the first media signal and the playback of the second media signal by the physical keyboard 11 in the foregoing embodiment.

Specifically, the physical keyboard 11 may include the fourth key 3941, which may be a key for push/press, thereby facilitating the user to directly carry out an emergency call in an emergent situation, and the fourth operation may be an operation of single action such as a single pressing or continuous 2˜3 presses.

It should be noted that the fourth key 3941 may coexist on the physical keyboard 11 with the plurality of physical keys provided in the foregoing other embodiments which may perform transmission of the first media signal and the playback of the second media signal. For example, the physical keyboard 11 may include the first key 5a21, the second key 5a22, and the fourth key 3941 or may include the third key 6a31 and a fourth key 3941. The case illustrated in FIG. 20 is that the physical keyboard 11 includes the third key 6a31 and the fourth key 3941.

Actually, the fourth key 3941 may be spaced apart, by a preset distance, from other keys such as the first key 5a21, the second key 5a22 and the third key 6a31. For example, as shown in FIG. 20, the third key 6a31 is disposed on the right side of the lower portion of the front surface of the housing, and the fourth key 3941 is disposed on the left side of the region that the third key 6a31 lies in, with a longer distance from the third key 6a31.

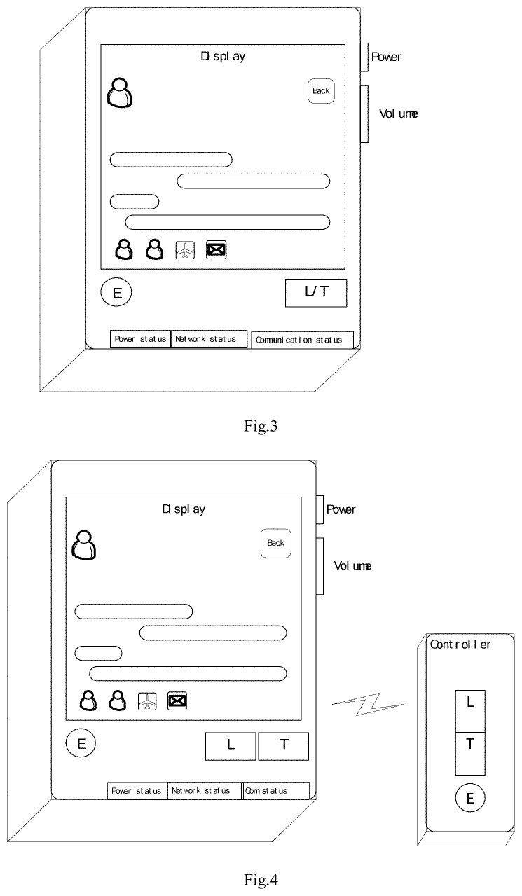

Optionally, the fourth key 3941 may be configured with different shape and/or size from the other keys, for example, the first key 5a21, the second key 5a22, the third key 6a31 are in rectangular shape, and the fourth key 3941 is in circular shape. Alternatively, the fourth key 3941 may have a different sign or logo with respect to the other keys. For example, the sign corresponding to the third key 6a31 illustrated in FIG. 3 is L/T, and the sign corresponding to the fourth key is E.

In practical scenario, the instant messaging application in the terminal communication device may have an emergency contact group with at least one contact built-in/preset therein. The emergency contact group generally includes at least two contacts in order to make sure that the user can successfully contact the emergency contact in an emergent case.

Therefore, when an emergency happened, the user may trigger, by only a certain preset operation on the fourth key 3941, the processor 12 to initiate an audio group call or video group call to member(s) of the emergency contact group via the Internet or the public switched telephone network. Optionally, an online video call may be performed via the Internet, and an audio call may be performed via the public switched telephone network.

Optionally, since the fourth key 3941 is a physical key for the user to initiate an emergency call in the case of emergency, to ensure that the fourth key 3941 can be more conveniently positioned by user in an emergency, the size and setting position of the fourth key 3941 may be different from other physical keys, for example, the fourth key 3941 may be spaced apart from other physical keys by a certain distance, and with a larger size.

Several optional implementations of the physical keyboard 11 provided in the embodiments of the present invention have been described above. Practically and optionally, the physical keyboard 11 or the housing may further be configured with a prompt lamp reflective of the communication state of the terminal communication device. Optionally, the prompt lamp may be independently disposed on each physical key, or one or more prompt lamps may be disposed on the physical keyboard 11 with no one-to-one correspondence to the physical key(s). For example, a prompt lamp indicative of receiving the communication message may be included, such as the communication status indicating lamp illustrated in FIG. 3, which may flash or highlight as receiving a message such as the second media signal mentioned above, thereby prompting that the message was received.

To sum up, the user only needs to perform simple operations on the at least one physical key included in the physical keyboard 11 to address different communication requirements by virtue of the physical keyboard 11 provided on the terminal communication device in the embodiment of the present invention. The timeliness and reliability that the user send the communication message to the contact and the real time/immediacy of communication message received from the contact are also guaranteed, as well as it is convenience for operation.

Based on the foregoing implementation means of the physical keyboard 11, the terminal communication device provided in this application may further include one or two pairs of direction keys for the user to select the display content on the display such as the contact related information displayed by the communication application. That is to say, the selection of the contact may be enabled by the direction key.

Optionally, the pair of direction keys is disposed on side(s), in the horizontal direction, of the first key 5a21 and/or the second key 5a22, or disposed on side(s), in the horizontal direction, of the third key 6a31. The pair of direction keys may be disposed, in appearance, adjacently or integrally with at least one of the first key 5a21, the second key 5a22, and the third key 6a31. As shown in FIG. 21, FIG. 21 is a view showing that the direction key 4032 is provided on the left side and right side of the third key 6a31.

In some embodiments, the profile or the interactive interface of the first contact or the contact group to which the first contact belonging is presented on the first User Interface when the terminal communication device is started, meanwhile, the processor 12 may respond to the user pressing the direction key on the right side of the first key so as to switch to display, on the screen, the profile or the interactive interface for the 2nd contact, or the contact group to which the 2nd contact belongs.

Optionally, the first contact is a contact that is most frequently contacted by user statistically, and access frequency, by the user, of the second contact and the third contact thereafter statistically decreases progressively.

Similarly, the processor 12 may also switch, by the display, from the profile or the interactive interface for the second contact to the profile or the interactive interface for the first contact, or from the contact group to which the second contact belonging to the contact group that the first contact belongs to in response to the user pressing the direction key on the left side of the first key, which will not be repeated herein.

When the user selects a contact, for example the second contact, on the display by the direction keys, subsequently, the user may continue to press the second key 5a22 to play the voice message from the second contact, or make a long press on the first key 5a21 so as to send the voice message to the second contact. Of course, the user may also initiate an audio or video call to the second contact via the Internet, by synchronously pressing the first key 5a21 and the second key 5a22 or pressing the third key 6a31, which will not be repeated herein.

In some embodiments, the contact related information or a portal for the common application will be displayed on the screen when the user presses the direction key on the right side of the first key 5a21/the second key 5a22 for the Nth time; and the processor 12 will switch to the interface for the normal mobile phone desktop on the screen, including resources such as multiple application icons, in response to the user pressing the direction key on the right side of the first key 5a21/second key 5a22 for the “N+1”th time. The user may use the interface for the normal mobile phone desktop to run various applications and operate the terminal communication device in an operating manner for a conventional mobile communication device such as a mobile phone.

Optionally, the processor 12 may always switch to a preset interactive interface in response to a predetermined gesture applied by user on the screen, regardless that the User Interface (UI) lies in, with the user's operation, the profile or the interactive interface for the contact or the contact group to which the contact belonging, or running interface for various application by the above interface for the normal mobile phone desktop. For example, the processor may switch to a preset interactive interface, on the screen, such as a profile interface for a particular contact, or back to the initial interface, in response to the user applying a Z shape sliding gesture or a sliding gesture along the diagonal of the screen.

The foregoing introduces several implementations for physical keyboard 11 of the communication device, in practical application, the communication device may also have different implementation variations. For example, the communication device may be implemented as a communication terminal such as a smart phone or a tablet, or may be implemented as a portable terminal device, or may be further implemented as a remote controller, and the like. In the following, several specific implementations will be introduced in conjunction with the following embodiments.

Detachable Design for Button and Main Body

In an optional embodiment, as shown in FIG. 3, the communication device is implemented as a communication terminal such as a smart phone or a tablet. The physical keyboard illustrated in FIG. 3 includes the third key and a fourth key mentioned in the foregoing embodiments, wherein the third key is illustrated by a key with an sign of L/T, and the fourth key illustrated by a key with a sign of E. Meanwhile, the front side of the communication device further includes a display with a larger size, and the display supports a triggering operation, thus also being referred to as a touch screen, for displaying interface elements, such as the interactive interface for the contact, illustrated in FIG. 3. FIG. 3 illustrates a case that physical keyboard is located in a position below the display, however, the physical keyboard may also be located on the left or right side of the display, for example, which should not be taken as limitation.

Besides, in some optional embodiments, there may be a prompt lamp reflective of the running state of the communication device, disposed on the housing of the communication device. For example, the prompt lamp is a lamp (such as the power prompt lamp as illustrated in FIG. 3) for indicating whether the power is sufficient, which will flash or blink when the battery is low so as to prompt the user to charge the communication device; for example, a prompt lamp (such as the network status prompt lamp as shown in FIG. 3) for indicating the network connection status, which blinks or lights when the network quality is abnormal to prompt the user network is poor.

Furthermore, as shown in FIG. 3, there may be a power key and a volume adjustment key disposed on the side of the communication device.

In another optional embodiment, as shown in FIG. 4, the communication device is implemented as a remote controller in cooperation with a smart terminal. The communication, wireless or wired, may be established between the remote controller and the smart terminal, for example, by communication means such as Bluetooth and infrared.

The physical keyboard introduced in the foregoing embodiments may be disposed in the remote controller. However, optionally, there may be a second physical keyboard disposed in the smart terminal as well. Furthermore, the instant messaging application mentioned in the foregoing embodiment may also be installed in the smart terminal.

The physical keyboard located in the remote controller, as illustrated in FIG. 4, includes a first key, a second key, and a fourth key, wherein the first key is illustrated by a key with a sign of L, and the second key is illustrated by a key with “T” sign, the fourth key is illustrated by a key with “E” sign.

In still another alternative embodiment, as shown in FIG. 5, the communication device is implemented as a portable terminal device, and the terminal device may be provided with the physical keyboard in other related embodiments and one or more pieces of displays ZFL_0023.

The physical keyboard disposed in the terminal device, as illustrated in FIG. 5, includes the first key, the second key, and the fourth key, wherein the first key is illustrated by a key with L sign, and the second key is illustrated by a key with “T” sign, the fourth key is illustrated by a key with “E” sign.

The terminal device illustrated in FIG. 5 is provided with two pieces of digital displays, each of which is associated with two switching keys. Optionally, the first digital display is employed to present the contact information in switching manner, and the second digital display may be employed to display the number of unread messages and switch to reveal the unread messages corresponding to the contact(s) displayed on the first digital display.

It should be noted that the “recording voice message and/or video/image message as a mark” mentioned in the foregoing embodiments is mainly embodied in the present embodiment as: displaying the contact information, the number of partial types of unread and unread messages by the digital display wherein the partial type of unread message may be voice/text message.

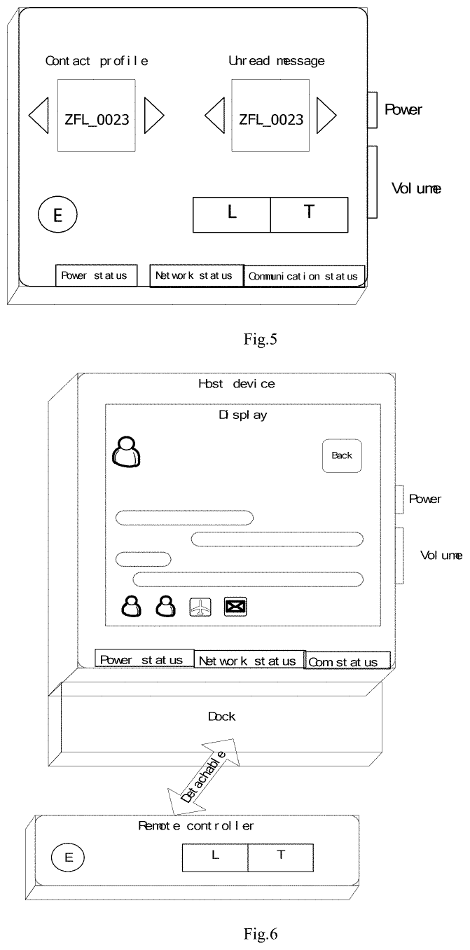

In still another alternative embodiment, as shown in FIG. 6, the communication device is implemented as a terminal device with a detachable controller. The physical keyboard introduced in the foregoing embodiments may be disposed in the controller, and the controller is connected to the main body of the terminal device through a connection interface. Namely, the physical keyboard is a independent physical component, which is detachably disposed on the housing of the device and communicatively coupled to the processor 12 via a wired and/or wireless interface. The physical keyboard in the controller, as illustrated in FIG. 6, comprises the first key, the second key, and the fourth key, wherein the first key is illustrated by a key with a sign of L, and the second key is illustrated by a key with a sign of T, the fourth key is illustrated by a key with a sign of E.

Of course, it should be noted that the communication device or the electronic device, according to any one embodiment of the present invention, is not limited to an integrally assembled device such as a mobile phone, and the respective functional units of the communication device or the electronic device may exist in a distributed manner independently. For example, the display for the electronic device may be a physically independent display unit such as a television set or the like. For another instance, the physical keyboard with one or more keys in the embodiment of FIG. 6 may also be independent of the processor unit, communicatively coupled to the processor unit in a detachable manner, either wireless or wired.

Integrated Interactive Interface

It should be appreciated that any of the methods or devices, according to embodiments of the present invention, recited under the headline “integrated interactive interface”, may be combined with the recitations of the method or device according to some embodiments of the present invention, including but not limited to those relevant embodiments under the headlines of “key/button arrangement and its modality and function”, “ button and host the detachable design”, or seek for implementing means therein.

In the research for the electronic device, for example, mobile device such as mobile phone, the inventors have found that different applications independently receive and present data and utilize communication resources in prior art of software system and communication system, and each application has independent interaction hierarchy designed, and there is no possibility to integrate the data and resources of each application for the user to use, which is an unrecognized requirement in the prior art, correspondingly causing the lack of related solutions. Under the existing architecture of operating system software and application software, the user needs to separately perform independent interaction for different applications in the process of accessing to the target data by the interactive interface of the electronic device, which reduces the efficiency for the user to access to data or information for different applications.

For the electronic device in some of the following embodiments, a electronic device with communication function, for example a mobile phone. will be taken as an example to describe the method or device of the embodiment of the present invention. FIG. 7 is a schematic diagram of a system architecture for establishing communication with a contact by a mobile terminal in the prior art. Hereinafter, the inefficiency in user acquiring data from multiple applications by human-computer interaction will be described with reference to FIG. 7. As shown in FIG. 7, the human-machine interaction and the accessing relationship between the human and program, in the prior art, may be clearly expressed. In the prior art, it is oriented towards a plurality of communication applications in the operating system that communication resources are configured, which requires the user to separately access to different application 1101 and 1102, and the like, even for the multiple types of messages of an identical contact such as short messages (SMS) and voice message. And these different messages correspond to different services, and may come from different communication networks, namely occur via different communication networks or corresponding network interfaces respectively. For example, these different messages may come from the mobile phone network 1108 and the WLAN (Wireless Local Area Networks) network 1107, the distributed/scattered configuration of communication resources for the identical contact 1103 is due to the diversified development of evolution of the communication network on one hand, and the diversity of the application development ecosystem in the development of software technology on the other hand. Of course, there may be still other reasons, but anyway, this leads to the information of contact 1103 being scattered/dispersedly stored in different applications, and the abovementioned multiple kind of messages, similar to the contacts, also need to be processed by different applications and stored in different applications in scattered/disperse way. Furthermore, this status also leads to the fact that the user 1104 has to access different applications, such as application 1101 and the application 1102, and the like, and the user has to perform different or somewhat repeated, great number of, multi-level interactions for each application to get the corresponding information. Moreover, each application has its own independent interactive interface and information presentation manner, and there is no possibility of integrating these applications with the user interaction oriented.

Method and Device for Providing Graphical Elements Across Interface

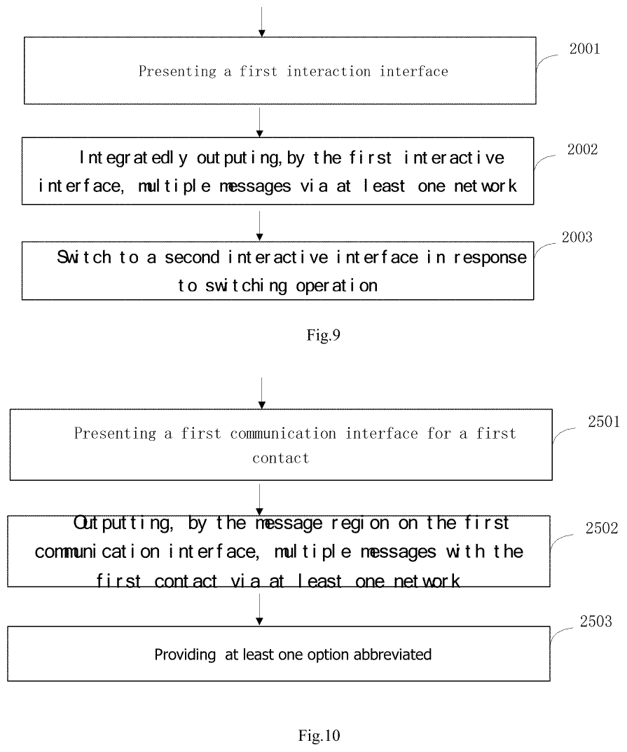

Based on the discovery of the shortage(s) of the prior art and research of the corresponding potential requirements by the inventor. A resource providing method for an electronic device is provided in one embodiment of the present invention. Optionally, the method may be run at the electronic device with processor unit, memory and display, and FIG. 9 is a flow chart showing a method for providing an interface element according to this embodiment of the present invention, as shown in FIG. 9, the interface element providing method includes:

in step 2001, displaying a first interactive interface at the electronic device.

in step 2002, integrally/integratedly outputting, by the first interactive interface, a plurality of messages corresponding to at least one communication network.

Optionally, the plurality of messages is generated by the communication via the at least one communication network, for example, the plurality of messages may be the voice message or the video message transmitted via the at least one communication network, or the telephone records of incoming/outgoing call via/over at least one communication network, and the like.

In step 2003, switching to present a second interactive interface at the electronic device in response to the switching operation.

Optionally, the first interactive interface and the second interactive interface are respectively provided with a first user interface element and a second user interface element which formally or functionally correspond to each other, and the first user interface element for the first user interface is associated with/coupled to the at least one communication network.

Correspondingly, in another embodiment of the present invention, an electronic device is further provided, the electronic device includes: a display; processor unit; memory; and one or more programs, wherein the one or more programs are stored in the memory and configured to be executed by the processor unit to: i) display the first interactive interface at the electronic device; ii) integrally output, by the first interactive interface, the plurality of messages corresponding to the at least one communication network; iii) switch to display the second interactive interface at the electronic device in response to the switching operation. The user interface elements are correspondingly provided on the first interactive interface and the second interactive interface respectively; wherein the user interface element in the first interactive interface is associated with the at least one communication network. Processor may work to establish a plurality of messages via a plurality of communication networks available to the electronic device in response to the user operation on the user interface element.

Integrated Communication by Multiple Networks

In the method according to some embodiments of the present invention, including those relevant embodiments under the headlines of “Configuration of interface and main interface”, “Integrated interactive interface”, “Single card mode”, for the user to communicate with the first contact via the first contact interface, the resource providing method in the electronic device may comprise three steps: step 4201, step 4202, and step 4203, as shown in FIG. 23, which shows a flow diagram of a resource providing method for an electronic device according to one embodiment.

In step 4201, a communication interface for the first contact is presented on the display for presenting message(s) between the user and the first contact, and optionally, the communication interface for the first contact may be configured to present a profile of the first contact.

In step 4202, in response to the user operation of/on the operation interface for communication, the communication is established with the first contact, via the at least one communication network, to generate a plurality of messages. In step 4203, the plurality of messages with the contact is output via the communication interface for the first contact.

Optionally, in some methods of embodiments in the present invention, including those relevant embodiments under the headlines of “Configuration of interface and main interface”, “Integrated interactive interface”, “Some embodiments of the first resource providing method”, “Single card mode”, the at least one communication network comprises a plurality of communication networks with different service properties, and the operation interface for communication may comprise virtual key group that is virtually provided on the communication interface for the first contact, the virtual key group is associated/coupled with the plurality of communication networks respectively. The operation interface for communication may also comprise physical key group that is physically provided to the electronic device, the physical key group is associated/coupled with a plurality of communication networks respectively. Both of the virtual key group and the physical key group may be configured in the electronic device, and may independently establish communication with current contact on the communication interface in response to the user operation respectively on the both.

Optionally, in some methods of embodiments in the present invention, including those relevant embodiments under the headlines of “Configuration of interface and main interface”, “Integrated interactive interface” and “Single card mode”, the plurality of communication networks comprise a plurality of wireless communication networks, the plurality of wireless communication networks comprise the mobile telephony network and the wireless data transmission network. The virtual key group and/or physical key group is associated with the mobile telephony network and the wireless data transmission network, respectively, and the method or the message outputting step 4202 may further comprise: establishing communication with the first contact to generate a plurality of messages via the mobile telephony network and the wireless data transmission network respectively, in response to the user operation of the key group.

Optionally, in some methods of embodiments in the present invention, including those relevant embodiments under the headlines of “Configuration of interface and main interface”, “Integrated interactive interface” and “Single card mode”, the plurality of messages comprises at least two of: the voice service message, the SMS message, and the data service message. The method or the message outputting step 4202 may further comprise two sub-steps for the case in which the key group, in different time periods, is associated with/coupled to different communication networks with different service properties: 1) when the key group is operable to activate a communication via the mobile telephony network, establishing the communication with the first contact via the mobile telephony network to generate the voice service message and/or the SMS message in response to the user operation of the key group; and 2) when the key group is operable to activate a communication via the wireless data transmission network, establishing the communication with the first contact via wireless data transmission network to generate the data service message in response to the user operation of the key group. Optionally, the wireless data transmission network comprises the WLAN or the mobile data network.

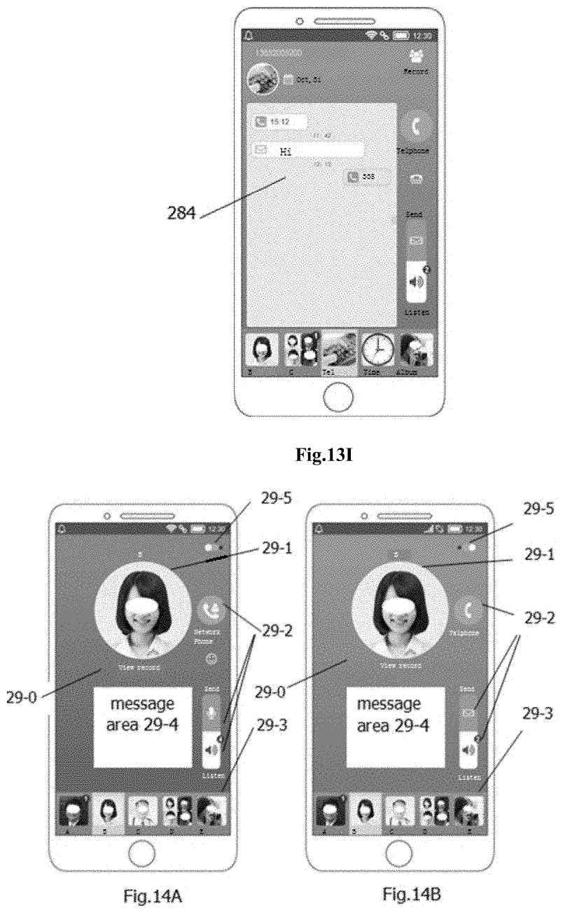

FIG. 14A-FIG. 14B are schematic diagrams of instant messaging and mobile telephony network communication according to embodiment of the present invention. The method of some embodiments of the present invention, including the relevant embodiments under the headline of “Configuration interface and main interface”, “Integrated interactive interface”, and “single card mode” will be further described hereinafter in combination with the set of diagrams.

FIG. 25A shows a network communication interface 29-0 for a single contact, which has a scrolling function bar comprising a plurality of contacts, or named sliding function bar 29-3, and the communication interface 29-0 further comprises a plurality of operational options, such as virtual key group 29-2 for the user to trigger so as to communication interact with current contact based on the mobile data network or WLAN currently accessed by the electronic device. The communication mode switching option 29-5 is also provided on the interface 29-0 as shown in FIG. 14A. The one or more programs stored in the electronic device may be executed by the processor unit to selectively configure the key group 29-2 to be associated with communication network(s) with different service properties, for example the mobile telephony network and/or the wireless data transmission network, in response to the user operation of the communication mode switching option 29-5. And the one or more programs stored in the electronic device may be executed by the processor unit to establish the communication with corresponding service property via the communication network associated with the key group 29-2, in response to user operation of the key group 29-2. Or the key group may be selectively configured to be associated with the mobile telephony network or the wireless data transmission network according to the connection status between the electronic device and the WLAN. Specifically, the electronic device may respectively configure the virtual key group or the physical key group to be associated with the wireless data transmission network and the mobile telephony network in response to the connection and disconnection of the electronic device with WLAN, which may be referred to the relevant embodiments and the details are not repeated herein.

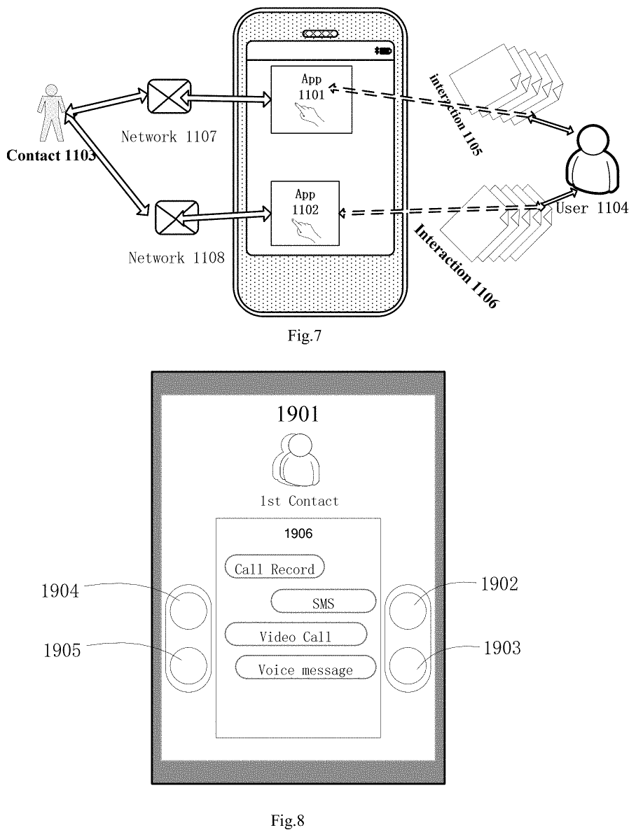

Specifically, when the user triggers the communication mode switching option 29-5 on the interface as shown in FIG. 14A, the electronic device will transition to a mobile phone communication interface for the single contact, as shown in FIG. 14B, and the interface comprises a slidable navigation window area 29-3 of a plurality of contact options and application options, still maintaining multiple operation options such as the key group 29-2 for the user to operate to communicate and interact with current contact based on the mobile telephony network. For example, the user may make a voice call, via the mobile telephony network, with the round key at the top of the key group 29-2, or the user may also operate the two keys in the middle or lower part of the key group 29-2 to perform “playing the short message” “sending short message” respectively. All the relevant message(s) generated by the user's operation on the communication key group 29-2 is output to the message area 29-4, and the communication mode switching option 29-5 is also provided on the communication interface 29-0 for the first contact for the user to trigger so as to switch back to the network communication interface shown in FIG. 14A. In the network communication interface 29-0 of the first contact shown in FIG. 14A, the virtual key group 29-2 may be operated by the user to perform communication interaction with the current contact based on the mobile data network or the WLAN currently accessed by the electronic device. For example, the user may operate the round key at the top of the key group 29-2 to make a voice call via the mobile telephony network or wireless data transmission network alternatively. For example, the electronic device may selectively make a video call/voice call to the first contact via the WLAN, in response to the user operation of the round key at the top of the key group 29-2, and If the call fails due to the network fault or the first contact offline, the electronic device will directly switch the communication network, and again make a voice call to the first contact via the mobile telephony network. This way of establishing communication based on two backup communication networks will not be repeated herein. The user is also allowed to operate the middle or lower two keys in the key group 29-2 to perform “playing voice messages” and “sending voice messages” via the WLAN or the mobile data network respectively, and all the relevant message(s) generated by the user operation of key group 29-2 is outputted to the message area 29-4. It should be noted that herein, in respect of the message area 29-4 on the communication interface for the first contact 29-0, the message area 29-4 in FIG. 14B may be used only for outputting the message(s) such as the SMS service and voice call service generated via the mobile telephony network, and the message area 29-4 in FIG. 14A may be used only for outputting the message(s) of the data service generated via the wireless data transmission network particularly WLAN, which corresponds to the communication function with which the communication key group 29-2 is dynamically configured. Of course, in the electronic device, the plurality of messages of three types with different service properties may be collectively presented in the message area 29-4 on the communication interface 29-0 for the first contact. Optionally, meanwhile, the number of the virtual key group 29-2 set on the communication interface for the first contact 29-0 may be increased, thereby allowing a larger number of key in the virtual key groups 29-2 to respectively couple/associate with the mobile telephony network and the wireless data transmission network, and consequently allowing the user to more conveniently establish communication with the first contact via the mobile telephony network and the wireless data transmission network by the communication interface 29-0 for the first contact, which may be referred to the embodiment in FIG. 8, and will not repeated herein.

In some embodiment(s), when associated with different communication network(s), the virtual key group 29-2, on the contact communication interface, retains formal consistency, thereby resulting in the case that for the user, appearance of the interface elements for different networks are consistent. In terms of user experience, it is equivalent to the case that multi-network has been integrated into one, so that the user may not perceive the diversity of communication networks, and a unified user interface under the network conditions of multiple networks may be provided, which gives the user a user experience of “using single network”. Furthermore, in the process of establishing communication by the SMS service, a conversion of “voice→text” or “text→voice” is performed, which allows the user to audibly acquire SMS message and audibly send SMS message. In view of this, the externally required interaction operation for the SMS service by the electronic device is equivalent/similar to the interaction operation required for the playing and sending of the voice message of the data service. This makes changes of the communication network or communication service in use imperceptible for the user, which improves the operability of the device across the network communication and consistent accessibility of multi-network resources for the user.

The communication mode switching option 29-5 is also provided on the communication interface for the first contact 29-0 for the user to trigger to switch back to the communication interface shown in FIG. 14A from the communication interface shown in FIG. 14B, the communication interfaces shown in FIG. 14B and FIG. 14A are all the communication interface for the first contact. Or the both may be appreciated as two different states of the communication interface for the first contact, respectively corresponding to two different states of the “mobile phone mode” and the “internet mode” of the electronic device. The main difference between the two different states lies in the different communication resources provided to the user in the electronic device, which may be referred to the relevant content under the headline of “Integrated communication by multiple networks” and will not be repeated herein. For the “mobile phone mode” and “internet mode”, the overall background color of the communication interface for the first contact may be differentiated, for example, respectively set to be blue and green, or the like, so as to facilitate the user to easily distinguish the two possible states of electronic device. In response to the user operation of communication mode switching option 29-5, the electronic device correspondingly switches to present the interface shown in FIG. 14A or the interface shown in FIG. 14B. Optionally, the electronic device may switch data links between the WLAN and the mobile data network of mobile communication network while switching the interfaces as shown in FIG. 14A and FIG. 14B and redefining the communication functions of the interface elements thereon, thereby distinctively carrying data traffic that may occur in the electronic device.

Optionally, the plurality of messages in the resource providing method of some embodiments of the present invention falls into two or more different categories of service properties, respectively. The first application interface element and the communication interface element respectively comprise the virtual key group 29-2. The virtual key group 29-2, as on the communication interface, is associated with the at least one communication network; and the message outputting step further comprises: establishing communication with the current contact or the current contact group to generate a plurality of messages via the at least one communication network, in response to the user operation of the virtual key group 29-2 on the communication interface; and integrally outputting the plurality of messages via the message area 29-4.

Optionally, in some resource providing methods of the embodiments of the present invention, the plurality of wireless communication networks comprise the mobile telephony network, the wireless data transmission network, the wireless data transmission network comprises the WLAN and/or the mobile data network; and the virtual key group 29-2 may be reused in divided time so as to be respectively associated with the mobile telephony network and the wireless data transmission network in different time periods, and the message outputting step in the resource providing method of the embodiment of the present invention further comprises: establishing communication with current contact or current contact group, respectively via the mobile telephony network and the wireless data transmission network, so as to generate a plurality of messages in response to the user operation of the virtual key group 29-2 on communication interface 29-0; and integrally outputting the plurality of messages, for current contact or current contact group, to the message area 29-4.

Optionally, some methods of embodiments in the present invention, including those relevant embodiments under the headlines of “Configuration of interface and main interface”, “Integrated interactive interface” and “Single card mode” further comprise: providing the profile 29-1, such as a avatar, an identity, etc., of the current contact or the current contact group on the communication interface 29-0. And the plurality of messages with different service properties in the embodiment comprises messages via the mobile telephony network which further comprises: the voice service message, the SMS message. The plurality of messages with different service properties further comprises the data service message over the WLAN or the mobile data network, and the data service message may further comprise one or more of the following: the audio message, the video message, the picture message, the geographical location, the text message, file, data, etc.

The integrally outputting step in the resource providing method of some embodiments of the present invention further comprises: temporally and collectively outputting, in the message area, any two or all the three types of messages of the voice service message, the SMS message, and the data service message in an identical time period.

Optionally, in some methods of embodiments in the present invention, including those relevant embodiments under the headlines of “Configuration of interface and main interface”, “Integrated interactive interface” and “Single card mode”, after having been integrated, the resources such as the message(s) between the contact and the user, the relevant communication networks, and the communication operation options on the contact communication interface may correspond to an identical contact, namely, the unique ID (or instant messaging address) corresponding to the instant communication tool for this contact and the cell phone number for this contact are stored in the mobile phone concurrently, certainly the cell phone number being also unique. Furthermore, the different communication tools used to communicate with the contact and the addresses of these communication tools corresponding to the communication network(s) are all integrally saved in an identical communication application of the electronic device. Additionally, the communication application may also store the profile such as the contact's avatar, name, identity, interpersonal relationship, and the like. This improves the accessibility of the message(s) for the user, as well as the operability of the electronic device.

The instant messaging and the mobile phone communication function are integrated after the electronic device such as the cell phone operates the method of the embodiment of the present invention, and only one set of Contacts needs to be maintained, while there is no need to switch between software, accessible by one identical software interface. Specifically, in the cell phone running the method of the embodiment in the present invention, two communication modes are provided for one contact, named as Internet mode and mobile phone mode, and the two modes may be switched to each other by one operation on the communication mode switching option 29-5 as shown in FIG. 14. The configuration for the resources of the cell phone, in the Internet mode, are oriented towards providing instant communication functions, such as non-real time voice message, pictures, videos, articles, location sharing, or the like. The configuration for the resources of the cell phone, in the mobile phone mode, are oriented towards providing mobile telephony network functions, such as making call, sending and receiving short message, or the like. And the steps of the method or the electronic device in some embodiments of the present application and relevant interfaces are illustrated with the Internet mode as examples, but it should be appreciated that the resource providing method for the Internet mode and its relevant communication interface, interactive interface, interface configuration method and steps are also applicable to the mobile phone mode, and vice versa.

It is worth noting that in the Internet mode, the virtual key group 29-2 is associated, in communication function, with a wireless data transmission network such as the WLAN or the mobile data network. Among the instant messaging that occurs between the user and the contact and the contact group by the communication interface, the communication resources of the data service are preferentially provided to the user by the contact interface. For some users such as the elderly, optionally, in this Internet mode, the message(s) received and sent by the user may be asymmetric. For example, the message type sent by the user through the message area 29-4 and the complexity of the operation for sending message are simplified, but the operation for the user receiving the message through the message area 29-4 and the resources involved are supported as much as possible. The type of message may be diverse because these received message may come from young people who are good at utilizing software and smart phone.

Optionally, for the asymmetry between sending message and receiving message, many types of non-real-time messages may be received by the user, and the messages possibly received comprise voice, text message, independent emotion, integrated picture-text message, picture and video, etc. In the aspect of sending message, less types of non-real-time message such as voice messages and independent emoji may be provided for the user to select when editing message, thereby resulting in a simple and practical user experience for the user such as the elderly. Optionally, the independent emotion generally refers to independent emoji, rather than an emoji embedded in the text message.

As for the asymmetry, on the other hand, the user may receive more types of real-time message(s), that may comprise the voice call and the video call. There is little type of real-time message(s) for the user may send, which may comprise only the video call, and the contact who is called may answer this video call by selecting a video or voice mode; wherein the real-time and non-real-time refer respectively to the user replying the message by a real-time response or by a delayed response in communication process.

Integrating and Storing a Plurality of Communication Network Messages for the Contact in a Single Program

In respect of the communication tool of the contact, such as the IM software or the cell phone, the corresponding cell phone number thereof in the mobile communication network, or the corresponding identification code (ID) thereof (or appreciated as an instant messaging address) in the wireless data transmission network, such as the WLAN, all stored or integrated in an identical program, for example, a communication application for the contact, thereby allowing the communication application, in the operation by the user, to establish communication with the communication tool used by current contact according to the cell phone number and unique identification code corresponding to the contact in the instant communication mode via the mobile telephony network and the wireless data transmission network respectively so as to generate messages. To some extent, the contact communication application integrates the main functions of both mobile communication (e.g. mobile telephony network based) and instant messaging (IM) software. For a user of an electronic device such as a cell phone, she/he perceives or and experiences only one single communication means/communication tool by a communication application to which the communication interface belongs. Moreover, resources for messages with different service properties in the communication process comprise communication interfaces for the communication network corresponding to different service properties, located at the lower layer of the software architecture, and the interactive interfaces for outputting the plurality of messages, located in the upper layer of the software architecture, both of the communication interfaces and interactive interfaces are all integrated into a single program. This is different from the following two cases: i) a plurality of communication interfaces with different service properties are configured in a plurality of different applications, and the plurality of messages with different service properties generated through the plurality of communication interfaces is collectively presented on an identical interactive interface only by means of forwarding the plurality of messages between different programs, or the like; ii) unique identification code (ID) for instant messaging and the cell phone number are configured in the plurality of different applications, and the plurality of messages with different service properties generated by the identification code of instant messaging and the cell phone number is collectively presented on an identical interactive interface only by means of forwarding the plurality of messages between different programs, or the like. The content herein are also applicable to the corresponding scenarios of all related embodiments described above or below.

Single Card Mode

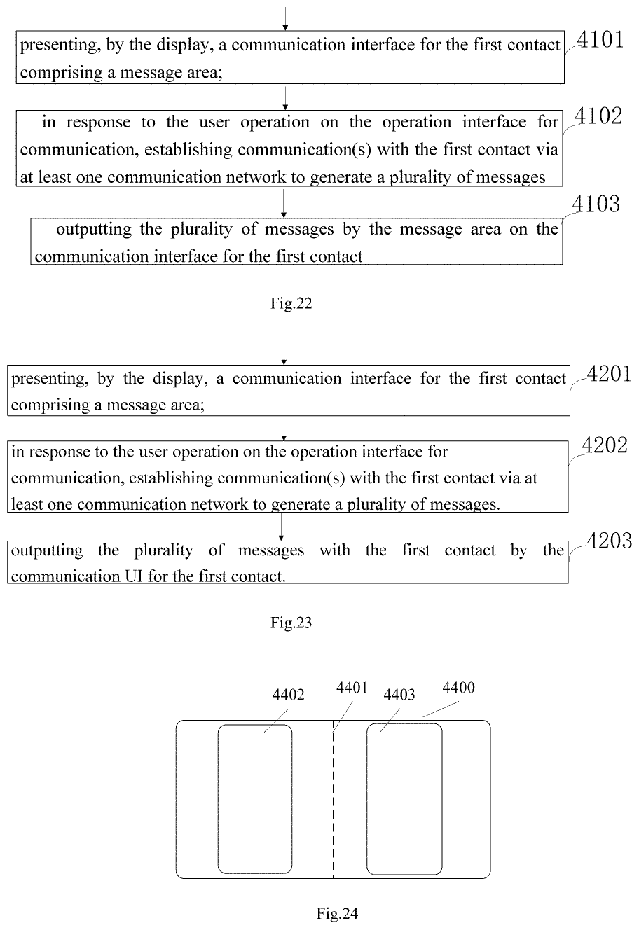

In some methods of embodiments in the present invention, including the embodiments under the headlines of “Configuration of interface and main interface”, “Integrated interactive interface” and “Integrated communication by multiple networks”, in the user's communication with the first contact by the first contact interface, the resource providing method in the electronic device may comprise three steps: step 4101, step 4102, and step 4103, as shown in FIG. 22, which shows a flow diagram of a resource providing method for the electronic device according to an embodiment of the present invention.

In step 4101, a communication interface for the first contact is presented on the display, and the communication interface for the first contact(or referred to as first contact communication interface), includes a message area for accommodating message between the user and the first contact.

In step 4102, in response to the user operation of/on the operation interface for communication, a communication is established with the first contact via at least one communication network to generate a plurality of messages.

In step 4103, the plurality of messages occurred between the user and the first contact is output by the message area on the communication interface for the first contact.

It should be noted that, in this or other embodiment(s), the recitation of “establishing communication(s) with the first contact” also means “establishing communication(s) with the electronic device operated/owned by the first contact” from the technical aspect.

Optionally, in some methods of embodiments in the present invention, including the embodiments under the headlines of “Configuration of interface and main interface”, “Integrated interactive interface” and “Integrated communication by multiple networks”, the message(s), occurred with the contact, may be classified into one, two or more different service properties, correspondingly, the at least one communication network may also comprise only one communication network or comprise two or more communication networks. For example, the at least one communication network may be one or more of the mobile telephony network, the mobile data network and the WLAN. If the plurality of messages involves two or more types of service properties, the step 4103 may further comprise: integrally providing the plurality of messages to the message area of the first contact communication interface in the electronic device such as the cell phone. And it should be appreciated that, for the sake of simplicity, in some embodiments of the present invention, the method and the electronic device related to the headline of the “single card mode” will be described in the case of two or more communication networks, but these embodiments are also applicable to the case where the at least a communication network comprises only one communication network.

Optionally, in some methods of embodiments in the present invention, including the embodiments under the headlines of “Configuration of interface and main interface”, “Integrated interactive interface” and “Integrated communication by multiple networks”, by the message area on the first contact communication interface, the message(s), occurred between the user and the contact, may be output in a plurality of different manners, or the information such as some indications for other applications may be output by the message area, such as an alarm clock timing information, calendar predetermined event expiration reminders, etc.

Optionally, according to a simplified outputting message concept, in some methods of embodiments in the present invention, including the embodiments under the headlines of “Configuration of interface and main interface”, “Integrated interactive interface” and “Integrated communication by multiple networks”, the outputting step 4103 may further comprise: separately outputting the latest one in the message area in response to the occurrence of the latest one of the plurality of messages.

Optionally, in some methods of embodiments in the present invention, including the embodiments under the headlines of “Configuration of interface and main interface”, “Integrated interactive interface” and “Integrated communication by multiple networks”, the outputting step 4103 may further comprise: outputting only the latest one, continuously being updated, of the plurality of messages in/to/into the message area on the first contact communication interface.

The message outputting manner of “one at a time” in some embodiments of the present invention, including the embodiments under the headline of “Configuration of interface and main interface”, “Integrated interactive interface” and “Integrated communication by multiple networks” will be hereinafter described in detail in combination with FIG. 14 and FIG. 15.

Furthermore, FIG. 14A to FIG. 14B are schematic diagrams for mode of instant communication network and mode of communication by mobile telephony network according to embodiments of the present invention. Taking FIG. 14A/B as an example, optionally, the at least one communication network comprises a plurality of wireless communication networks, and the plurality of wireless communication networks further comprises the mobile telephony network and the wireless data transmission network, and the wireless data transmission network comprises the WLAN and/or the mobile data network. The communication interface for the first contact 29-0 is further provided with the key group 29-2, which is respectively associated with the mobile telephony network and the wireless data transmission network. And the electronic device may establish communication to generate a plurality of messages with different service properties via the communication network in response to the user click operation on the key group 29-2. The electronic device may establish the communication with the first contact, via the mobile telephony network and the wireless data transmission network respectively, to generate a plurality of messages in response to the user operation of key group 29-2, and the plurality of messages comprises: the messages over the mobile telephony network and the data service message; the messages over the mobile telephony network comprises: the voice service message and the SMS message.

Optionally, in some methods of embodiments of the present invention, including the embodiments under the headlines of “Configuration of interface and main interface”, “Integrated interactive interface” and “Integrated communication by multiple networks”, in the “integrally outputting step”, furthermore, the at least two of the voice service message, the SMS message, and the data service message may be integrally output to the message area 29-4.

Specifically, further embodiment for the above “integrally outputting” may be partially referred to the description of the method and the relevant contact interface of the embodiment shown in FIG. 8. In the embodiment shown in FIG. 8, more keys are concurrently/synchronously disposed in the key group 29-2 on the contact interface, thereby enabling each key to be (diversely) associated with a communication network with a different service property.

In another further embodiment for the “integrally outputting”, in the electronic device, the integrally outputting of the message may be performed on the first contact interface in a manner of reuse in divided time. Specifically, when the key group 29-2 is associated with the mobile telephony network, in response to the user clicking operation of the key group 29-2, the electronic device may establish communication, via the mobile telephony network, to generate both the voice service message and the SMS message, and integrally output two of the voice service message and the SMS message with the first contact by the message area 29-4 on the first contact communication interface, or output only one of them, for example the SMS message. Besides, when the key group 29-2 is associated with the WLAN or the mobile data network, in response to the user clicking operation of the key group 29-2, the electronic device may establish the communication and generate data service messages via the WLAN or the mobile data network, and output the data service message by the message area 29-4 on the communication interface for the first contact. In this embodiment of the method of integrally outputting message by the first contact communication interface, the consistency may be formed among the key group 29-2 and its associated communication network and the type of messages output by the message area 29-4, which is convenient for the user to operate and recognize information categories.

It should be appreciated that the above is merely an exemplary illustration, in fact, it may be substantially independent among the key group 29-2 and its associated communication network and the type of message(s) output by the message area 29-4. For example, i) the key group 29-2 is associated with the WLAN or the mobile data network the key group 29-2 may be operated by the user to transmit the data service message via the WLAN or the mobile data network, and ii) when the key group 29-2 is associated with the mobile telephony network, the key group 29-2 may be operated by the user to transmit the voice service message and the SMS message via the mobile telephony network. In the above two cases, the message(s) output by the message area 29-4 may concurrently/synchronously comprise three kinds of messages: the voice service message, the SMS message, and the data service message. This may enable the user, for example to obtain, by the message area 29-4, the message(s) with data service property such as the voice message that the first contact sent via the mobile data network or the WLAN, and meanwhile the voice message from the first contact may be replied by means of short message service via the mobile telephony network by user operating the key group 29-2 associated with the mobile telephony network on the first contact interface. Similarly, the key group 29-2 provided on the first contact interface may also be synchronously associated with the mobile telephony network and the wireless data transmission network. The association between the key group 29-2 and the corresponding communication network is diverse, for example, the first key in the key group 29-2 may be defined to cause the electronic device to send message(s) of SMS type via the mobile telephony network in response to the user single click operation and send message(s) of the data service via the mobile data network or the WLAN in response to the user double-click operation. Of course, more keys may be disposed for the key group 29-2, so that each key may be associated with a communication network with a different service property. The specific embodiments may be referred to the description and relevant contact interface of the method in the embodiment shown in FIG. 8, which will not be repeated herein. In the embodiment shown in FIG. 8, if the user of the electronic device needs to operate the communication key group, the user interface elements, so as to establish communication by communication networks of different service property, it is not necessary for the user to operate the communication mode switching option 29-5 in FIG. 14A/B to switch the association between the communication key group and the communication network of different service properties, which enables the user to directly access the communication network with different service properties by a single operation on the communication interface for the first contact, thereby further improving the accessibility of communication resources and messages in the electronic device.

In the instant messaging software of the prior art, the design of the interactive interface is derived from the instant messaging tools for the personal computer, such as ICQ, Tencent QQ, etc., that is, using the interface for chatting record as the elementary background of the entire communication interface, but for the user who does not have to pay much attention to the chatting record, this arrangement mode of the interface elements on the communication interface excessively/extra occupies the screen display space of the electronic device, and too rich information deprives the user of the attention to the current message or newer message.

FIG. 15A-FIG. 15C are schematic diagrams showing communication interfaces for the first contact that may switching between “single card mode” and “communication record displaying mode” provided by the method of the embodiment of the present invention. In the methods of the embodiments shown in FIG. 15A-FIG. 15B of the present invention, some interface configuration methods for simplified instant messaging interaction are also proposed. Optionally, FIG. 15A and FIG. 15B are schematic diagrams of interfaces for independently displaying a separate message in the method according to the embodiment(s) of the present invention. The resource providing method and the interface configuration method proposed by the related embodiments of the present invention, will be described below with reference to the FIG. 14A/B, FIG. 15A and FIG. 15B. Optionally, the communication interface for the first contact is provided with the first contact's profile 29-1, located above the message area 29-4. The integrally outputting step in the method of the embodiment may further comprise: separately outputting the latest one in the message area in response to the occurrence, receiving or sending, of the latest one of the plurality of messages. For example, the electronic device has previously generated the plurality of messages comprising: a) one SMS message with the first contact via the mobile telephony network, sent from the first contact to the electronic device 1 minute ago, b) 2 voice call records with the first contact via the mobile telephony network, called out 25 minutes ago and called in 30 minutes ago, respectively lasting 35 seconds and 3 minutes, and c) 3 voice messages, from the mobile data network, received 2 hours ago. Temporally, the short message in a) is the latest one. The electronic device separately outputs only the SMS message in the message area 29-4 without displaying any other message(s) in b) and c). At the current time, the user of the electronic device sends, by operating the middle key in the key group 29-2, a voice message of the data service to the first contact via the WLAN associated with the middle key, and the electronic device updates to display the latest voice message in the message area 29-4, as shown in FIG. 14A or FIG. 15A. Of course, outputting the latest message in the continuously updating manner by the message area may be performed during the process of sending or receiving the message(s), or may be after the completion of the reception or transmission of the message(s), for example, the message area 29-4 is updated to output only the latest message, about 1-10 seconds after transmission of the voice message is completed. In another aspect, the electronic device may separately output, in the message area of the first contact communication interface, the latest one of the three types of message(s), such as the voice service message, the SMS message, and the data service message between the user and the first contact, and with more messages being continuously generated, the electronic device may output, continuously updating, the latest one of message(s) in the message area, which will not be repeated. Of course, only the latest one of at least two of the three types of message(s) may be output, with the latest one being continuously updated, to the message area of the communication interface for the first contact. For example, only the latest one of the plurality of messages of witch the service property belongs to the voice service and the short message service is output to the message area(not shown in the figure) of the interface. The messages of the voice service comprises the message(s) such as the call duration of the incoming/outgoing call and the call occurrence time via mobile telephony network, which is applicable to all other embodiments and will not be repeated in detail herein. Alternatively, only the latest one of the plurality of messages of which the service property belongs to the short message service and the data service may be output to the message area of the first contact interface.

Optionally, the association or the consistency may also be formed and retained among the key group 30-2 and its associated communication network(s) and the type of message(s) output by the message area 30-4. For example, when the key group 30-2 is associated with the mobile telephony network, in response to the occurrence of the latest one of the messages over the mobile telephony network, the electronic device will separately output, in the message area, the latest one of the messages over mobile telephony network. In other words, only the latest one of the plurality of messages, of which the service property belongs to the voice service and the short message service, is output to the message area (not shown in the figure) of the interface, namely, outputting the latest one, separately and being updated continuously, of messages in/into the message area. Whenever one of messages with two kinds of service properties occurs, for example being received/sent, the message area will be substantially updated to output the message that has just occurred. Alternatively, only the latest one, while/as being updated continuously, of the plurality of messages of which the service property belongs to the voice service is output to the message area (not shown in the figure). meanwhile, it is another optional variation that only the latest one, while being updated continuously, of the plurality of messages of which the service property belongs to the short message service be output to the message area, which is not repeated herein.

Alternatively, when the key group 30-2 is associated with the WLAN or the mobile data network, in response to the occurrence of the latest one data service message, the latest one data service message, such as the separate one of message in the message area 30-4 as shown in FIG. 15B, will be separately output in the message area, the latest one data service message may be the textual message from the current contact by the data service. In other words, the electronic device separately displays, in the message area 30-4, only the latest one of the plurality of messages of which the service property belongs to the data service. Moreover, the latest data service message keeps being continuously updated in the message area 30-4 with the most recent message occurring to the electronic device, that is, whenever one message of data service occurs, this latest one message will be separately output in the message area 30-4. Of course, the data service message comprises one or more of the following: the audio message, the video message, the picture message, the geographic location, the text message, the file, the data, and the video call and the voice call, etc. established via the WLAN or the mobile data network, which will not be repeated herein.

This mode of displaying only one, at a time, of the latest message, or simply referred to as a message, may be simply referred to as a “single card mode”, and the interface elements arrangement for the “single card mode” may satisfy the requirement of instant messaging in most cases, one or more messages may be serially output, one by one, in the message area, the “one forth one back”/“one incoming one outgoing” mode improves the order of the message flow output by the electronic device to the user, and the user experience for the user to acquires the message is more plain, intuitive and straightforward. Of course, apart from the “one forth one back”/“one incoming one outgoing” mode, the round-trip(back and forth) of the message may also comprise: electronic device feeding back a message after receiving a plurality of messages, which may be simply referred to “one forth multiple back”. In some embodiments, for the way of “one forth one back/one incoming one outgoing ” or “one forth multiple back”, these messages, outgoing and incoming, in the message area may be presented preferably in the manner of “displaying only one at a time”, for example, only displaying the most recent one message.

When the communication application to which the contact communication interface belongs in FIG. 15A or FIG. 15B accumulates a plurality of unread message for the current contact, the electronic device also supports the user to further view more chatting records that have occurred with the current contact by the operation of/on the current contact communication interface.

In the method of some embodiments, if the user applies an operation of a common or particular interaction gesture such as a click, a double click, or the like to the profile 30-1 or the message area 30-4 in FIG. 15B, then as shown in FIG. 15C, the electronic device will extend the message area 30-4, on the communication interface, in response to a predetermined operation by the user, thereby being adapted for accommodating more messages and allowing more messages to be collectively output in the message area 30-4. Meanwhile, optionally, the electronic device may configure the profile information 30-1, in an abbreviate manner, on the communication interface for the first contact to reduce the display area occupied by the profile on the interface, thereby facilitating the extension of the message area. The profile information 30-1 may be configured out of and above the message area 30-4. Corresponding to the extension of the message area, the electronic device may collectively output the plurality of messages in the message area 30-4 of FIG. 15C in the process of integrally outputting the plurality of messages, rather than displaying only the latest one of the plurality of messages in the message area, of course, the collective presentation of the plurality of messages in the message area may be temporally arranged according to the occurrence time of the respective message.

Optionally, in respect of the message area 30-4 for collectively presenting historical message(s) in the FIG. 15C, the resource providing method of the embodiment of the present invention further allows the user to selectively browse the message(s) of desired date by the calendar option 30-9. Apart from presenting the corresponding historical message(s) in response to the user's dragging and scrolling, the message area may pop up a calendar floating layer interface (not shown in the figure) for the user to select a date in response to the user' operation on the calendar options 30-9 on the communication interface, the message(s) of the corresponding date is retrieved and loaded in the message area 30-4 according to the specific date selected by the user on the calendar floating layer interface. Thus, the historical message(s) desired by the user may be located mainly by at most one or two operations by the user on a single layer of the first contact communication interface, which further simplifies the requirements for the user's interactive operation.

Optionally, the association or consistency is formed among the key group 30-2 in FIG. 15C and its associated communication network and the type of message(s) output by the message area 30-4. When the key group 30-2 in FIG. 15C is associated with the mobile telephony network, the message(s) via the mobile telephony network will be collectively output in the message area 30-4 of FIG. 15C in a temporal order, instead of the case that only the latest one of the plurality of messages belonging to the voice service or the SMS service is displayed in the message area; when the key group 30-2 in FIG. 15C is associated with the WLAN or the mobile data network, the data service message will be collectively output in the message area 30-4 of FIG. 15C temporally, instead of always only the latest one of the data service messages being displayed in the message area.

The manner in which the message area on the first contact communication interface separately displays the latest single one message of the plurality of messages may be simply referred to as the “single card mode”. The collectively outputting of two or more messages by the extended message area may be simply referred to as a communication record displaying mode. Of course, in response to the user switching operation, after the electronic device enters the communication record displaying mode from the single card mode, the electronic device may also need to return from the communication record displaying mode in FIG. 15C back to the single card mode as shown in FIG. 15B in response to the user's another switching operation. Specifically, the electronic device may reduce the message area and present the profile extended to be in the size for single card mode as shown in FIG. 15B in response to the user operation of the profile or the message area of the first contact communication interface in FIG. 15C. Correspondingly, the electronic device may also switch to the single card mode shown in FIG. 15B by the following steps, thereby integrally outputting a plurality of messages by the message area of the first contact communication interface, for example, separately outputting the latest one of the plurality of messages in the message area in FIG. 15B, in other words, whenever a piece of message is generated, then the message or only the message, newly generated, is output by the message area. Or, optionally, the association or the consistency may be formed among the key group 30-2 in FIG. 15B and its associated communication network and the type of message(s) output by the message area 30-4. Specifically, when the key group 30-2 is associated with the mobile telephony network, the newly generated message, received or sent, over the mobile telephony network will be separately output in the message area 30-4; when the key group is associated/coupled with the WLAN or the mobile data network, the latest one of the data service messages will be separately output in the message area. It may be referred to the description of the corresponding sections in other embodiments under the headline of “Single card mode”, which will not be repeated herein.

Of course, from another aspect, the first contact communication interface in FIG. 15B and FIG. 15C may be regarded as two sub-communication interfaces for the first contact communication interface, for example, the first contact communication interface in FIG. 15A and FIG. 15B may be referred to as profile interface, and the first contact communication interface illustrated in FIG. 15C may be referred to as communication record interface. Either the profile interface or the communication record interface comprises the profile and message area for the current contact, as shown in FIG. 15B and FIG. 15C. The profile on the communication record interface in FIG. 15C is abbreviatedly configured with respect to the profile on the profile interface in FIG. 15A or FIG. 15B, the message area on the profile interface in FIG. 15A is used for accommodating one single piece of communication record, while the message area of the communication record interface in FIG. 15C is configured to accommodate a plurality of communication records and more messages with respect to the profile interface in FIG. 15A. The electronic device may switch to present the communication record interface in FIG. 15C on the display in response to the user operation of the message area or profile on the profile interface in FIG. 15B. Of course, the display may also switch to present the profile interface of FIG. 15B on the display in response to user operation of the message area or profile on the communication record interface in FIG. 15C. Thus, the user may switch between the profile interface in FIG. 15B and the communication record interface in FIG. 15C respectively via the operation of/on respective profile or message area on the profile interface in FIG. 15B or the communication record interface in FIG. 15C. The user switching operation may be a common or specific interaction gesture operation such as click, double click, etc., and the interaction gesture may be predefined and saved in the electronic device.

Optionally, the switching between the single card mode and the communication record displaying mode in the electronic device is similar to the switching between the profile interface shown in FIG. 15B and the communication record interface shown in FIG. 15C. Such switching may be performed in response to a switching operation explicitly/actively applied by the user on the profile or the message area. Alternatively, in the profile interface shown in FIG. 15B, when two or more unread message occurs, the electronic device is configured to automatically switch to the communication record interface shown in FIG. 15C, or when two or more unread message occurs, the electronic device is configured to post prompt information (not shown in the figure) in the message area on the profile interface shown in FIG. 15B, thereby notifying the user with the plurality of messages unread, and the electronic device may switch to the communication record interface shown in FIG. 15C in response to the user selecting operation of the prompt information. Of course, the prompt information may be posted continuously or intermittently, namely, the following two items are alternately output in the message area: 1) the prompt information of “a plurality of unread message” or “accumulated unread message” and 2) the latest unread message(s). Moreover, as described above, electronic device may also switch to the communication record interface shown in FIG. 15C in response to user clicking the region for or around the profile such as the avatar of current contact in the profile interface shown in FIG. 15B. Herein, the electronic device posts a notification of a plurality of unread message(s) on the first contact interface, and the electronic device may prejudge whether the relevant message(s) has been read by the user. For example, when one message has been received and output by the message area for more than 1 minute, then the message may be regarded as read. Alternatively, 1) after the message(s) is generated, it is subjected to the user operation, such as a gesture of clicking, sliding, or the like, or 2) the resources such as the camera and display of the electronic device judges and captures that the user is visually interacting or physically interacting with current contact communication interface of the electronic device, 3) playing the audio message (no need for the message has been played entirely), 4) enlarging shorter text message or operation on relevant readable options, 5) enlarging or playing for longer text message, picture or video, if any of the above occurs, the relevant message(s) for the current contact that occurs during this interaction phase may be determined to be of the “have been read” state.

For some users, for example, who expects a simplified interaction and a visual focus for UI, the resource providing method or the interaction method provided by the embodiments of the present invention lays emphasis the rounding of the message(s) in the daily communication process.

The messages is presented in the manner of “one at a time”, that is, only the latest message, read or unread, is displayed for each time, or, optionally, only the received message from the contact is displayed, but the message from the user of the electronic device to the contact is not displayed. This simplifies the user interaction process and stays focused on the latest message. The layout of the communication interface is clear/clean and simple, and there is enough space left for presenting the profile such as the contact avatar.

Optionally, in the method of the embodiment, the contact communication interface belongs to a single program, generally speaking, the plurality of interfaces configured in the electronic device may also belong to the single program or the multiple associated programs. In the method of the embodiment, a conventional operating system such as Android may be customized to integrate the contact interface related program(s) into an operating system of the electronic device so as to constitute a system-level single program and the program component(s) related to the communication application interface operates as the operating system user interface (UI), and the plurality of interfaces such as contact communication interfaces in the single program will be presented to the user at the first time after the startup is completed. Therefore, the single program is also loaded during the startup of the operating system of the electronic device. With the single program or multiple associated programs operated in the startup phase of the electronic device, the single program exclusively occupies the display of the electronic device, located at the top layer of the software interaction hierarchy of the electronic device, preferably, the contact communication interface is loaded at the top of the software interaction hierarchy of the electronic device, and the contact communication interface is side by side/parallel to the other interfaces of the plurality of interfaces configured in the applications on the top layer of the software interaction hierarchy of the electronic device, thereby allowing the user to access, by the display, the contact communication interface and the other interfaces of the plurality of interfaces, which may be switched to each other. Therefore, the contact communication interface and the like in the embodiment may be automatically loaded and displayed on the display after the startup process of the electronic device, and furthermore, the communication interface in the “single card mode”, the profile interface, etc. is loaded as the default home page for a normal work state of the electronic device after startup, thereby allowing the user to communicate with the relevant contacts. Loading the single program described above, during the startup phase, enables the communication interface such as the one in the “single card mode” to be automatically loaded at the top of the interaction hierarchy of the entire software system of the electronic device.

In some embodiments according to the present invention, a computer readable storage medium is also provided with instructions stored therein, which when executed by an electronic device with one or more processors, cause the electronic device to perform any operation of the methods of the present application, under the headlines including but not limited to “Configuration of interface and main interface”, “Integrated interactive interface”, Integrated communication by multiple networks, “Electronic device with a detachable base” and “Single card mode”.

In some embodiments according to the present invention, a non-transitory computer readable storage medium is also provided, comprising one or more programs executed by one or more processors of an electronic device, the one or more programs further comprise operations or instructions, which when executed by the one or more processors, cause the electronic device to perform any method under the headlines including but not limited to “Configuration of interface and main interface”, “Integrated interactive interface”, “Integrated communication by multiple networks”, “Electronic device with a detachable base” and “Single card mode”.

In some embodiments according to the present invention, an electronic device is also provided, comprising: a display, a processor unit and a touch-sensitive surface unit, the touch-sensitive surface unit is configured to detect a contact; wherein the processor unit is coupled with the display and the touch-sensitive surface unit, and the processor unit is programmed to execute the operation/instruction of any method under the headlines including but not limited to “Configuration of interface and main interface”, “Integrated interactive interface”, “Integrated communication by multiple networks”, “Electronic device with a detachable base” and “Single card mode”.

In some embodiments according to the present invention, an electronic device is also provided, comprising: a processor unit, memory and one or more programs, wherein the one or more programs are stored in the memory and configured to be executed by the processor unit, the one or more programs comprise the operations or instructions, which when executed by the one or more processors, cause the electronic device to perform any method of the present application, under the headlines including but not limited to “Configuration of interface and main interface”, “Integrated interactive interface”, “Integrated communication by multiple networks”, “Electronic device with a detachable base” and “Single card mode”.

Furthermore, it should be noted that: all the steps proposed for the method and definitions or descriptions of various modules/units for the electronic device in all the embodiments under the headline of “single card mode” are also applicable to and may be combined with the method or electronic device and communication apparatus proposed in all the embodiments including the embodiments under the headlines of “Integrated interactive interface”, “Integrated communication by multiple networks”, “Electronic device with a detachable base”.

Electronic Device with a Detachable Base

In the method or electronic device and communication apparatus proposed in all the embodiments including those embodiments under the headlines of “Integrated interactive interface”, “Integrated communication by multiple networks”, “Configuration of interface and main interface”, the user interface elements for the user to operate for interaction with the application interface, or the operation interface for communication for the user to operate for interaction with the communication interface may be virtual key groups provided, in the form of software, on the communication interface/the application interface, or may be physical key groups physically provided in the electronic device, and these physical key groups and virtual key groups are respectively associated with a plurality of wireless communication networks. Thus, for the current contact communication interface, the electronic device may establish communication with the current contact via the plurality of wireless communication networks to generate a plurality of messages in response to the user operation of the virtual or physical key group; and integrally output the plurality of messages by the message area on the current contact communication interface. It should be appreciated that the plurality of messages, or also referred to as multiple types of messages, may correspond to two or more different types of service property/attribute, for example, the plurality of messages may comprise: message(s) of the voice service via the mobile telephony network, message(s) of the short message service via the mobile telephony network, message(s) of the data service via the wireless data transmission network such as the mobile data network or the WLAN. the “plurality of messages” herein is also applicable to any other related embodiments, which will not be repeated.

The following will take the key group physically embodied by hardware-on the electronic device as an example. And description in combination with the figures will be made for the physical key group, the electronic device configured with the physical key group and capable of being operated substantially or completely dependent on the user's operation on the physical part(s), and the electronic device enabling the user to establish communication by operating the physical key group in the embodiment including the embodiments related to the headlines of “Integrated interactive interface”, “Integrated communication by multiple networks”, “Configuration of interface and main interface”. Furthermore, the electronic device may further comprise a communication device, such as a cell phone, and a base, both of which may be combined in a detachable manner.

In some embodiments of the present invention, a terminal communication device is also provided, as shown in FIG. 16, and FIG. 14, the terminal communication device comprises: a base and a first mobile terminal 5, wherein the base comprises: a body 4; a settlement portion 411, formed on the body 4 for resting the first mobile terminal 5; a physical operating portion disposed on the body 4; a first interface, disposed on the body 4, the first end thereof is coupled to the physical operating portion; a second interface, disposed on the first mobile terminal 5; the second end of the first interface is communicatively coupled to the second interface and detachable from the second interface; wherein the physical operating portion is operable to send signals to the first mobile terminal 5 through the first interface and the second interface, so as to trigger communication of the first mobile terminal 5 via the at least one communication network, for example, exchanging media data with a second terminal via the wireless data transmission network.

Furthermore, as described above, some electronic device/communication device according to some embodiments are mainly proposed from the hardware perspective under the headlines of “Electronic device with a detachable base” and “keys/buttons arrangement and its form and function”, the configuring method or providing method of software resources such as the user interface in the electronic device or the communication device may be referred to the configuring or providing method of software resources such as communication interface for the contact and user interface for applications provided in any embodiment of relevant embodiments under the headlines of “Configuration of interface and main interface”, “Integrated interactive interface”, “Single card mode” and the like, which will not be repeated again.

Optionally, the at least one communication network comprises a mobile telephony network, a wireless data transmission network, and the wireless data transmission network may comprise a WLAN and a mobile data network; the physical operating portion may comprise a first operating portion, and the first operating portion may cause, in response to an external operation thereon, the terminal communication device to send any of the following signals or a combination thereof to the first interface in response to the external operation on the first operating portion:

a first signal for requiring the first mobile terminal to establish a short message service via the mobile telephony network, a second signal for requiring the first mobile terminal to establish a voice call service via the mobile telephony network, and a third signal for requiring the first mobile terminal to transmit a data service message via the wireless data transmission network.

Optionally, the first operating portion comprises: a first key and a second key. Optionally, the first key is configured to cause the communication device(or to say, the processor connected with the physical operating portion in the communication device) to send, in response to a first operation thereon, the first signal or the second signal to the first interface. The second key is configured to cause, in response to a second operation, the terminal communication device to send the first signal or the second signal to the first interface in response to a second operation. Preferably, the signals caused by the first key and the second key to the first interface are different, namely, if the first key may cause the second signal to be sent to the first interface, then the second key will be configured to cause the first signal to be sent to the first interface.

Optionally, the first operating portion further comprises a third key, which is configured to cause the terminal communication device to send the second signal or the third signal to the first interface in response to a third operation on the third key, optionally, the third signal may be for indicating the first mobile terminal to initiate a request to another communication device for a real time call based on a wireless data transmission. As illustrated in FIG. 16, the first interface is a physical interface and is directly connected to the second interface on the host housing.

Besides, the second interface may be a physical interface disposed on the first mobile terminal 5, and the second interface matches/is adapted for the first interface. Further optionally, when the first interface is a physical interface, the first interface and the second interface constitute a spring probe connector, such as a Pogopin connector, and the first interface may preferably be an interface with a contact structure, for spring probe connector such as the probe interface of the Pogopin connector and the second interface may be set as the pinhole interface of the Pogopin connector.

Of course, regular data transmission interface, such as lightning interface or USB interface, on various mobile terminals in the market may be adopted as the first interface and the second interface, for adaptation to those mobile terminal that is conventionally designed and not customized for the base provided by some embodiments of the present invention. Optionally, the lightning interface and the Type-C type USB interface are preferred. In terms of communication coupling such as data interface protocol, data interface protocol, such as USB protocol or GPIO, may be adopted to support data transmission, audio and video transmission, and power supply.

Of course, the first interface may also be a wireless interface, wirelessly connected to the second interface through a short-range communication protocol such as Bluetooth or NFC.

When the wireless connection is employed, a wireless charging mechanism may also be disposed in the body 4, and the first mobile terminal 5 may be synchronously charged by the wireless charging mechanism. Meanwhile, the settlement portion 411 may not be formed as a fixed structure shown in FIG. 16, but may be simplified as a platform for the first mobile terminal 5 resting thereon.

No matter the physical interface or the wireless interface is employed, the connecting mechanism mechanism/fixing mechanism of the settlement portion 411 may include but not limited to a chute, a snap and a magnetic coupling mechanism and a combination mechanism by virtue of the gravity generated with the angle at which the device is placed.

It should be noted that the first interface may also be in adapted connection, by some adaptor mechanisms/components, such as connectors, connecting lines, etc., with other mobile terminals that are not compatible with the various physical interfaces or data interface protocols or that are not compatible with USB protocols, GPIO, and the like.

Optionally, the second terminal may generally be any mobile terminal located remotely. the mobile terminal may be different for different contacts, so the second terminal referred to in some embodiments of the present invention is not specific to a certain mobile terminal, that is, any possible mobile terminal that may conduct media data transmission with the first mobile terminal 5 may be defined as the second terminal.

With respect to the prior art, the terminal communication device, provided by some embodiments of the present invention, converts the operation for the first mobile terminal 5 into the physical operation with good feedback by means of the base and physical operating portion disposed on the base, which greatly improves convenience and is suitable for users including but not limited to the elderly, children, blind people and other people who are not good at operating the electronic device.

Specifically, the media data referred to in some embodiments of the present invention includes but not limited to various text messages, files, data, voice and video data, generated for the purpose of communication, between a plurality of mobile terminals. It is worth mentioning that when GSM network is employed for communication and call online, the cost is relatively high, and many people are sensitive to the call charge. In contrast, the exchange of media data via the wireless data network is often free or economic. However, for some people, it is often difficult to distinguish between GSM-based network and wireless-based data network, and it is difficult for them to find the way to access the wireless data network.

In some embodiments of the present invention, only with the operation on the physical operating portion(also named as physical key group in other embodiments), the first mobile terminal 5 will be caused to directly initiate the video call, send audio, text or picture data, etc. via the wireless data network, with respect to the prior art, it is obviously convenient in terms of operation, and it is obvious to make the user feel more satisfied with the charge. Optionally, some embodiments as mentioned above, the first mobile terminal 5 may recognize the connection with the first interface to switch the network, accessed by itself, to WLAN or 5G, 4G, so as to reduce the user's tariff burden.

Further optionally, the physical operating portion includes a first operating portion, and the first operating portion may cause, in response to an external operation, the communication device to send any of the following signals or a combination thereof to the first mobile terminal 5 via the first interface and the second interface in response to an external operation: i) a signal for indicating the first mobile terminal 5 to collect and send media data; i) a signal for indicating the first mobile terminal 5 to play media data; iii) a signal for indicating the first mobile terminal 5 to initiate a real-time call request to the second terminal based on wireless data transmission.

In the first operating portion, most functions for exchanging media data is integrated, which is very convenient. The first operating portion may be embodied in the form of a physical component for operation such as a key, a joystick, a handle, a touchpad, and the like. Specifically and optionally, the first operating portion comprises: a first key 21 that is configured to, in response to the first operation, send a signal for indicating the first mobile terminal 5 to collect and transmit the media data, to the first mobile terminal 5 via the first interface and the second interface. A second key 22 that is configured to, in response to the second operation, send a signal for indicating first mobile terminal 5 to play the media data, to the first mobile terminal 5 via the first interface and the second interface.

Optionally the first key 21 and the second key 22 may be adjacently disposed. The two physical keys may be in the shape of a square or a circular shape. The first key 21 and the second key 22 may also be disposed apart from each other, for example, one disposed on the first side of the housing and the other disposed on the second side of the body 4; or, the first key 21 and the second key 22 may also be distributed on the same side of the body 4.

Optionally, the first operating portion further comprises: a third key 23, configured to, in response to the third operation, send a signal for indicating the first mobile terminal 5 to initiate a first real-time call request over the wireless data transmission, to the first mobile terminal 5 via the first interface and the second interface.

The second terminal may be responsive to the real-time call request so as to realize the real-time call between the first mobile terminal 5 and the second terminal. The real-time call request referred to in some embodiments of the invention, including but not limited to the video call, the voice call and other kinds of real-time communication means.

Of course, for the electronic device in the above or below embodiments, if the effective display area of the display of the electronic device is large, such as a tablet or a display having a foldable screen or with a foldable capability; alternatively, in the case that the electronic device does not comprise a display, the display screen of the television may be employed to present the user interface of application such as instant messaging and interaction with user for the related video signal output by the electronic device. Correspondingly, on a display including but not limited to the mentioned several types of displays with bigger display area, two or more contact communication interfaces or other application interfaces such as photo album may be synchronously presented.

FIG. 24 is a schematic diagram showing a plurality of interactive interfaces synchronously displayed on a foldable display of an electronic device according to an embodiment of the present invention, in FIG. 24, the display 4400 is a display that may be folded at least along the linear region 4401, the first interface 4402 and the second interface 4403 may be dependently presented on the two sides of the linear area 4401, respectively. Optionally, the first interface 4402 may be a first interface for a first contact, and the second interface 4403 may be a second interface for a second contact or other application such as an album.

Therefore, it is not excluded that a plurality of contact interfaces and/or a plurality of application interfaces may be synchronously provided on the display in these embodiments. Optionally, the plurality of contact interfaces comprise a plurality of profile interfaces respectively for more contacts, more communication record interfaces respectively for more contacts.

The steps are numbered to make the description more concise, rather than strictly limiting the order relationship between the steps, and the steps of the method are exemplarily described in some order, The various steps of the method are described in a certain order, which are not limitations on the order relationship between the steps. The order between the steps and steps may be different from those described in some embodiments above. And in some context, section or paragraph of the specification, if the reference number and the referenced Figure are inconsistent/mismatched, the reference number shall prevail so as to help with understanding the embodiment(s), thereby redirecting to the relevant appended Figure to which the right reference should be made.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A resource providing method for an electronic device, wherein said electronic device comprises an operation interface for activating communication via at least one communication network, the method comprising: presenting a first communication UI for a first contact on a display for said electronic device, said first communication UI comprising a message area;
outputting a plurality of messages with a first contact via the at least one communication network to said message area at least partially in response to an operation of an operation interface by a user.

2. The method of claim 1, wherein said electronic device is configured with at least one interface according to the configuring operation by the user, said first communication UI being comprised by said at least one interface; the method further comprising:
providing at least one option on said display;
said at least one option is associated with said at least one interface respectively; said at least one option being operable to output said at least one interface in one-to-one correspondence via said display; said at least one option comprising a first option corresponding to said first communication UI.

3. The method of claim 2, wherein said at least one option is presented in an abbreviated form on a top/bottom of said display, or presented on a side of said display, the method further comprising the step of:
presenting the at least one option, slidable or scrollable in response to a switching operation for the at least one option by the user.

4. The method of claim 3, wherein said at least one option is at least partially arranged laterally at the bottom of said display, the step of sliding said at least one option further comprising:
sliding/scrolling said at least one option, portion by portion in response to said switching operation by the user; wherein each one portion comprises the same number of options, the same number being 3, 4, 5 or more.

5. The method of claim 4, wherein said at least one option further comprises a second option; the method further comprising: switching said first communication UI to an interface corresponding to said second option on said display, and synchronously differentiating said second option formally in response to a selecting operation of said second option by the user.

6. The method of claim 2, further comprising:
enabling/updating said first communication UI and/or said first option in a sequence in said electronic device in response to detecting an operation for adding/updating the first contact by the user; and
switching to output, on said display, said at least one interface according to the sequence in response to a switching operation for said at least one interface by the user.

7. The method of claim 2, wherein said at least one interface comprises a plurality of UIs,
said operation interface is virtually and/or physically provided in said electronic device;
said operation interface comprises I) at least one software key on said display and/or II) at least one hardware key in the housing of said electronic device;
the at least one software key corresponds to/matches the at least one hardware key in one or more of appearance, location, function;
said at least one software key and said at least one hardware key are operable to activate features of the current UI of said plurality of UIs; the method further comprising:
switching to output said plurality of UIs on said display in response to an switching operation for said plurality of UIs;
dynamically associating, with said plurality of UIs being switched, each of said at least one software key and said at least one hardware key with one feature of the application provided by the current UI.

8. The method of claim 1, wherein the at least one communication network comprises a plurality of wireless communication networks; said operation interface is virtually and/or physically provided in said electronic device;
said key group being operable to activate the communication via the plurality of wireless communication networks; said plurality of messages being with at least two service properties; and
the step of outputting messages further comprising: establishing communication with the electronic device owned by the first contact via the plurality of wireless communication networks in response to an operation of said key group by the user so as to generate said plurality of messages; and outputting said plurality of messages by said message area in said first communication UI.

9. The method of claim 8, wherein the plurality of wireless communication networks comprise a mobile phone network, a wireless data transmission network; said wireless data transmission network comprising a WLAN and/or a mobile data network; said key group being operable to activate the communication via the mobile phone network and the wireless data transmission network respectively, and the method or the message outputting step further comprising:
establishing the communication with the electronic device owned by the first contact to generate said plurality of messages via the mobile phone network and the wireless data transmission network respectively in response to a user operation of said key group, said plurality of messages comprising message of the mobile phone network and data service message; wherein the message of the mobile phone network comprises: voice service message and/or SMS message; said data service message comprising one or more of the following: audio message, video message, picture message, geographic location, text message, file and data.

10. The method claim 9, wherein the outputting step further comprises: integratedly outputting, in said message area, at least two of said voice service message, said SMS message and said data service message.

11. The method claim 10, wherein the integratedly outputting step further comprises:
outputting said voice service message and/or said SMS message by said message area in the case of said key group being for the mobile phone network; and
outputting said data service message by said message area in the case of said key group being for the WLAN or the mobile data network.

12. The method of claim 1, the outputting step further comprising:
A) outputting only the latest one of said plurality of messages in said message area in response to the occurrence of the latest one; or
B) continuously updating and outputting only the latest one of said plurality of messages in said message area.

13. The method of claim 12, wherein said plurality of messages comprise at least two of said voice service message, said SMS message and said data service message, any one of the outputting step A), step B), further comprising:
outputting, in said message area, only the latest one message via the mobile phone network in response to the occurrence of the latest one message via the mobile phone network; and
outputting, in said message area, only the latest one data service message in response to the occurrence of the latest one data service message via the WLAN or the mobile data network.

14. The method of claim 13, wherein said first communication UI comprises profile for the first contact, said profile for the first contact and said message area being arranged up and down substantially centrally on said first communication UI and equivalent in size;
said operation interface comprises a key group comprising I) one or more software keys on said display and/or II) one or more hardware keys in the housing of said electronic device; said one or more software keys being configured in a column in the left side or right side of said first communication UI;
the one or more software keys correspond to the one or more hardware keys in appearance and/or location and/or function;
the method further comprises the steps of:
expanding the message area in response to the user operation on the profile or the message area, shrinking the profile into a thumbnail above the message area, and
collectively outputting said plurality of messages in the expanded message area in a temporal/chronological order.

15. The method of claim 14, wherein i) a phone number for the mobile phone network corresponding to the first contact and ii) an identification for the wireless data transmission network corresponding to the first contact are integrated in a single program configured with said first communication UI,
said step of presenting said first communication UI further comprises: automatically loading said first communication UI on the display upon the completion of the startup/initialization of said electronic device;
the method further comprises the step of establishing the communication with the first contact by said phone number and/or said identification to generate said plurality of messages in response to an operation of said first plurality of keys and/or said second plurality of keys, respectively.

16. The method of claim 12, wherein the outputting step further comprises step A-B) displaying, in the message area, only a first message of said plurality of messages from/to the first contact; in response to a second message of said plurality of messages from/to the first contact, displaying only the second message in place of the first message in the message area.

17. The method of claim 16, wherein, the step A-B) further comprises:
A-1) in response to recently receiving the first message from the first contact, displaying only the first message in the message area; A-2) in response to the user activating said operation interface, sending the second message to the first contact; A-3) displaying the second message in place of the first message in the message area; and/or,
B-1) in response to the user activating said operation interface, sending the first message to the first contact;
B-2) displaying, in the message area, only the first message most recently sent;
B-3) in response to receiving the second message from the first contact, displaying the second message in place of the first message in the message area.

18. A computer readable storage medium storing one or more programs, the one or more programs comprising instructions, which when executed by an electronic device with a display, and a touch-sensitive surface, cause the device to perform the method of claim 12.

19. An electronic device, comprising:
a display; a touch-sensitive surface; one or more processors; memory; and one or more programs, wherein said one or more programs are stored in the memory and configured to be executed by the one or more processors, said one or more programs comprising instructions for performing the method of claim 7.
